(19) United States
(12) Patent Application Publication
(10) Pub. No.: US 2025/0084256 A1
(43) Pub. Date: Mar. 13, 2025

(54) REINFORCED NON-STICK COATING SYSTEM

(71) Applicant: PPG Industries Ohio, Inc., Cleveland, OH (US)

(72) Inventors: Matteo Sperindio, Cleveland, OH (US); Riccardo Piras, Cleveland, OH (US); Fabio Ravella, Cleveland, OH (US); Ian Jones, Cleveland, OH (US); Gianluca Cattinari, Cleveland, OH (US)

(73) Assignee: PPG Industries Ohio, Inc., Cleveland, OH (US)

(21) Appl. No.: 18/559,883

(22) PCT Filed: May 11, 2022
(86) PCT No.: PCT/US2022/028813

§ 371 Date: Nov. 9, 2023

Related U.S. Application Data
(60) Provisional application No. 63/187,033, filed on May 11, 2021.

(51) Int. Cl. C09D 5/16; C09D 7/40; C09D 7/61; C09D 171/00; C09D 179/08; C09D 181/02; C09D 183/06

(52) U.S. Cl. CPC C09D 5/1693; C09D 5/1675; C09D 7/61; C09D 7/69; C09D 171/00; C09D 179/08; C09D 181/02; C09D 183/06

(57) ABSTRACT

Coating compositions that may be applied to the surface of a substrate to form a durable non-stick coating. The coating compositions may include a basecoat composition and an overcoat composition for forming a basecoat and an overcoat applied over the basecoat. The basecoat may comprise one of an organic polymer, a sol-gel composition, and a silicon resin. The basecoat composition and resulting basecoat may further include reinforcing particles. The overcoat may comprise a siloxane matrix formed from one of a hydrosilylation reaction, a dehydrogenative coupling, and a polycondensation reaction. The basecoat and overcoat may each be substantially free of fluoropolymer components.

### CROSS-REFERENCE TO RELATED APPLICATIONS

The present application claims priority to U.S. Provisional Patent Application Ser. No. 63/107,033, entitled Reinforced Non-stick Coating System, filed on May 11, 2021, which is incorporated by reference herein in its entirety.

### BACKGROUND

### 1. Field of the Disclosure

The present disclosure provides a non-stick coating composition that may be applied to an interior, or food-contact, surface and/or to an exterior, or heat-contact, surface of an article of cookware or bakeware. A coating may be formed of the composition to provide a surface having properties such as desirable hardness, abrasion resistance, impact resistance, chemical resistance, and nonstick properties.

### 2. Background

Heat resistant coatings are applied to substrates such as cookware or bakeware to cover the substrate and to provide additional functions such as aiding in heat transfer, providing a non-stick release surface, and/or providing a decorative color or aesthetic finish. Prior coating compositions have either been based on fluoropolymers or have employed non-fluoropolymer base resins but tend to be brittle and potentially prone to crack-based defects which may limit their service life.

As an alternative, siloxane coatings based on sol-gel reactions may be used. Typical siloxane coatings based on sol-gel reactions form highly crosslinked matrices which tend to be very brittle and hard. The nonstick properties of these coatings may have a limited service life, as the coating layer may separate from the substrate or basecoat.

Improvements in the foregoing are desired.

### SUMMARY

The present disclosure provides coating compositions that may be applied to the surface of a substrate to form a durable non-stick coating. The coating compositions may include a basecoat composition and an overcoat composition for forming a basecoat and an overcoat applied over the basecoat. The basecoat may comprise one of an organic polymer, a sol-gel composition, a silicon resin, and combinations thereof. The basecoat composition and resulting basecoat may further include reinforcing particles. The overcoat may comprise a siloxane matrix formed from one of a hydrosilylation reaction, a dehydrogenative coupling, a polycondensation reaction, and combinations thereof. The basecoat and overcoat may each be substantially free of fluoropolymer components.

### BRIEF DESCRIPTION OF THE DRAWINGS

The above mentioned and other features of the disclosure, and the manner of attaining them, will become more apparent and the disclosure itself will be better understood by reference to the following description of aspects of the disclosure taken in conjunction with the accompanying drawings.

FIG. 1A shows an example substrate for the coatings of the present composition.

FIG. 1B shows an example cross section of the coatings of the present composition.

FIG. 2A shows a scratch adhesion picture of a silicon elastomer basecoat composition after scratch testing as described in Example 10.

FIG. 2B shows a cross section of a silicon elastomer basecoat composition after scratch testing as described in Example 10.

FIG. 3A shows a scratch adhesion picture of a silicon elastomer basecoat composition after scratch testing as described in Example 10.

FIG. 3B shows a cross section of a silicon elastomer basecoat composition after scratch testing as described in Example 10.

FIG. 4A shows a scratch adhesion picture of a sol-gel basecoat composition after scratch testing as described in Example 11.

FIG. 4B shows a cross section of a sol-gel basecoat composition after scratch testing as described in Example 11.

FIG. 5A shows a scratch adhesion picture of a sol-gel basecoat composition after scratch testing as described in Example 11.

FIG. 5B shows a cross section of a sol-gel basecoat composition after scratch testing as described in Example 11.

FIG. 6A shows a scratch adhesion picture of a sol-gel basecoat composition after scratch testing as described in Example 11.

FIG. 6B shows a cross section of a sol-gel basecoat composition after scratch testing as described in Example 11.

FIG. 7A shows a scratch adhesion picture of a sol-gel basecoat composition after scratch testing as described in Example 11.

FIG. 7B shows a cross section of a sol-gel basecoat composition after scratch testing as described in Example 11.

FIG. 8A shows a scratch adhesion picture of a polyether sulfone/polyamide-imide basecoat composition after scratch testing as described in Example 12.

FIG. 8B shows a cross section of a polyether sulfone/polyamide-imide basecoat composition after scratch testing as described in Example 12.

FIG. 9A shows a scratch adhesion picture of a polyether sulfone/polyamide-imide basecoat composition after scratch testing as described in Example 12.

FIG. 9B shows a cross section of a polyether sulfone/polyamide-imide basecoat composition after scratch testing as described in Example 12.

FIG. 10A shows a scratch adhesion picture of a polyether sulfone/polyamide-imide basecoat composition after scratch testing as described in Example 12.

FIG. 10B shows a cross section of a polyether sulfone/polyamide-imide basecoat composition after scratch testing as described in Example 12.

FIG. 11A shows a scratch adhesion picture of a sol-gel basecoat composition after scratch testing as described in Example 13.

FIG. 11B shows a cross section of a sol-gel basecoat composition after scratch testing as described in Example 13.

FIG. 12A shows a scratch adhesion picture of a silicon resin basecoat composition after scratch testing as described in Example 13.

FIG. 12B shows a cross section of a silicon resin basecoat composition after scratch testing as described in Example 13.

FIG. 13 shows a cross section of a silicon resin basecoat composition after scratch testing as described in Example 13.

FIG. 14A shows a scratch adhesion picture of a polyether sulfone basecoat composition after scratch testing as described in Example 13.

FIG. 14B shows a cross section of a polyether sulfone basecoat composition after scratch testing as described in Example 13.

FIG. 15A shows a scratch adhesion picture of a silicon elastomer basecoat composition after scratch testing as described in Example 13.

FIG. 15B shows a cross section of a silicon elastomer basecoat composition after scratch testing as described in Example 13.

FIG. 16 shows a cross section of a non-homogeneous coating.

FIG. 17 shows mechanical properties of the coatings of Example 15.

### DETAILED DESCRIPTION

### I. Introduction

The present disclosure provides compositions that may be applied to the surface of a substrate to form a durable non-stick coating. The coating may include a basecoat having reinforcing particles, and an overcoat disposed over the basecoat. The basecoat and overcoat may both lack fluoropolymer components used in prior non-stick coating compositions.

The basecoat may be one of several types. For example, the basecoat may comprise at least one of: (i) a sol-gel composition formed from a siloxane matrix, (ii) an organic polymer such as at least one of polyphenylene sulfide (PPS), polyethersulfone (PES), polyether ether ketone (PEEK), polyphenylsulfone (PPSU), polyamide-imides (PAI), polyetherimides (PEI), polyimide (PI), (iii) a silicon resin, and combinations thereof.

The basecoat may further comprise reinforcing particles, such as one or more hard particles embedded into a basecoat composition such that the basecoat composition is capable of holding the reinforcing particles in place and preventing their displacement. The reinforcing particles may assist in deflecting mechanical forces applied to the basecoat.

The coating may further include an overcoat comprising a siloxane matrix. The siloxane matrix may be formed from one or more of several reactions. For example, the siloxane matrix may be formed from a hydrosilylation reaction between a hydrosiloxane and a vinyl siloxane. Alternatively, the siloxane matrix may be formed from the dehydrogenative coupling between a hydrosiloxane and a hydroxysiloxane. As a further alternative, the siloxane matrix may be formed from a polycondensation reaction between hydroxysiloxanes or a polycondensation reaction between a hydroxysiloxane and an alkoxysiloxane, an acetoxysiloxane, or an oxime-modified silane.

The siloxane matrices of the sol-gel basecoat and the siloxane overcoat may both be described as being formed of organosiloxane-based solid polymers, which are typically thermoset systems capable of providing a range of mechanical characteristics, ranging from soft and rubbery to hard and brittle. The hardness of the system is generally proportional to the degree of crosslinking in the system. The degree of crosslinking may in turn be dependent upon the nature of the organosiloxane unit used in the system. As shown in Table 1 below, organosiloxanes may be described according to the degree of oxygen substitution, or functionality, on the central silicon.

TABLE 1

| Structural formula | Functionality | Symbol |
|---|---|---|
| R₃Si—O— | Monofunctional | M |
| 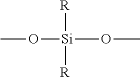 | Difunctional | D |
| 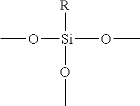 | Trifunctional | T |
| 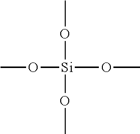 | Tetrafunctional | Q |

Generally, compositions including higher fractions of T (trifunctional) and Q (tetrafunctional) units display higher degrees of crosslinking.

Organosiloxane materials may also generally be characterized by a low surface free energy, providing enhanced hydrophobicity and oleophobicity. Hydrophobicity is generally proportional to the amount of organic substituents present in the polymer; in other words, a higher fraction of D (difunctional) and M (monofunctional) units. Thus, these properties may be said to be inversely proportional to the degree of crosslinking of the system, and therefore inversely proportional to the hardness of the polymer.

The present disclosure provides sol-gel compositions formed from organosiloxanes. The organosiloxane may be of the formula:

RₓSi(OR′)₄₋ₓ
wherein:
   R is one or more moieties chosen independently from linear, branched, or cyclic alkyl and aryl;
   R′ is methyl, ethyl, propyl or alkyl; and
   x is 0, 1, 2, or 3.

In the above formula, R may be C6 aryl or a linear or branched alkyl having from as few as 1, 2, 3, or as many as 4, 5, 6, or more carbon atoms, or a number of carbon atoms within any range defined between any two of the foregoing values. Alternatively, R may be selected from methyl, ethyl, propyl, and phenyl.

In the above formula, x is 0, 1, 2, or 3. Alternatively, x may be 1.

The organoalkoxysilane may be selected from the group consisting of: methyltrimethoxysilane, methyltriethoxysilane, dimethyldiethoxysilane, dimethyldimethoxysilane, trimethylmethoxysilane, trimethylethoxysilane, phenyltrimethoxysilane, phenyl triethoxysilane, and combinations of the foregoing.

The organoalkoxysilane may be a functionalized siloxane, such as 3-aminopropyltriethoxysilane, (3-glycidoxypropyl)trimethoxysilane, and allyltrimethoxysilane.

The components of the coating composition are described in further detail below.

### II. Definitions

For purposes of the following detailed description, it is to be understood that the disclosure may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

The use of the term “non-stick” herein is intended to mean a coating having release properties, particularly when the coating is applied to articles of cookware and/or bakeware. When the coating is applied to articles of cookware and/or bakeware, non-stick may pertain to food release properties, including food fouling release properties.

The term “siloxane matrix”, as used herein, is intended to mean a matrix including repeating covalent bonds between silicon and oxygen atoms, such as Si—O—Si or Si—O—Si—O, for example.

### III. Substrates

The coating composition may be applied to the surface of a substrate. Suitable substrates may include metals, ceramic materials, plastics, composites, and minerals. Suitable metals may include stainless steel, aluminum, and carbon steel, for example. Suitable ceramic materials include glasses like borosilicate glass, porcelain enamels, various fired clays and other refractory materials, for example. Suitable plastics and composites include high melting point plastics and composites, such as plastics having a melting point higher than the cure temperature of the coating formulation, including polyester, polypropylene, ABS, polyethylene, carbon fiber epoxy composites, and glass fiber epoxy composites, for example. Suitable minerals include micas, basalts, aluminas, silicas, and wollastonites, marble and granite, for example.

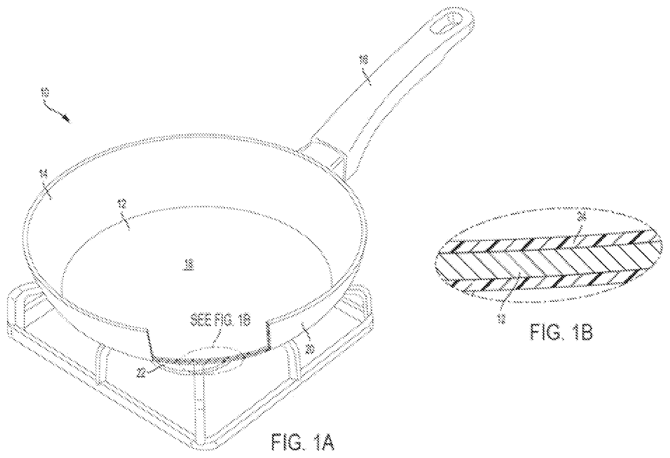

The substrate may be a portion of a pan or other article of cookware. Referring to FIG. 1A, an article of cookware 10 is shown in the form of a pan, which generally includes a circular bottom wall 12, an annular side wall 14, and a handle 16. Cookware article 10 is typically a metal or metal alloy such as stainless steel, aluminum, and carbon steel, but may also be a ceramic material, a plastic or a composite, for example.

Bottom and side walls 12 and 14 include an interior or food contact surface 18 facing the food to be cooked, as well as an opposite, exterior or heat contact surface 20 which, in use, faces, is adjacent to, or contacts a heat source or heating element 22. As shown in FIG. 1B, article of cookware 10 may include an interior coating 24 over at least a portion of its respective interior surface 18, including at least a portion of, or all of, bottom wall 12 and/or side walls 14.

In this manner, the present coating compositions may be used as either an interior coating or an exterior coating. Although article of cookware 10 is shown as a pan, the present coating compositions may also be used to form coatings for other articles of cookware, such as skillets, griddles, pots and the like, as well as articles of bakeware or other cooking articles which are exposed to heat in use.

The present coating compositions may also be used to coat non-cookware articles, such as rollers, molds, conduits and fasteners, which require a non-stick or release property and/or which are exposed to heat in use.

### IV. Coating System

It is desirable for coating systems used for cookware and bakeware to possess both non-stick features and resistance to abrasion. In the past, per- and poly-fluoroalkyl substances (PFAS) have been used in this capacity. However, demand has arisen for PFAS-free coatings. Organosiloxane-based systems may be used to form non-stick coatings instead of PFAS-containing compositions. The coating compostions of the present disclosure seek to maintain the non-stick properties of the organosiloxane system by applying it as a overcoat over a tougher basecoat to increase resistance to abrasion and scratching. The coating compositions of the present disclosure may be substatially free of PFAS.

Specifically, the present disclosure provides a multi-coat system and a composite structure. It has been found that the mechanical properties (such as resistance to abrasion) of the system can be enhanced by adopting a basecoat with a composition harder than the overcoat. The basecoat may be filled with an amount of hard particles to create a texture within the basecoat and optionally allowing at least some of the reinforcing particles or portions thereof to at least partially extend into the overcoat.

The reinforcing structure created by the hard particles may assist the overcoat to deflect the mechanical forces acting on the overcoat, thus minimizing the effect of scratching and abrasive action. As described above, the hard particles are embedded into a basecoat composition that is harder than the overcoat such that the basecoat composition is capable of holding the reinforcing particles in place and preventing their displacement.

The basecoat may comprise at least one of: (i) a sol-gel composition formed from a siloxane matrix, (ii) an organic polymer such as polyphenylene sulfide (PPS), polyethersulfone (PES), polyether ether ketone (PEEK), polyphenylsulfone (PPSU), polyamide-imides (PAI), polyetherimides (PEI), polyimide (PI), and combinations thereof, and (iii) a silicon resin. The coating may further comprise reinforcing particles. Any of the basecoat compositions may then be combined with any of the overcoat compositions described below.

The overcoat may comprise a siloxane matrix. The siloxane matrix may be formed from one or more of several reactions. For example, the siloxane matrix may be formed from a hydrosilylation reaction between a hydrosiloxane and a vinyl siloxane. Alternatively, the siloxane matrix may be formed from the dehydrogenative coupling between a hydrosiloxane and a hydroxysiloxane. As a further alternative, the siloxane matrix may be formed from a polycondensation reaction between hydroxysiloxanes or a polycondensation reaction between a hydroxysiloxane and an alkoxysiloxane, an acetoxysiloxane, or an oxime-modified silane. The overcoat itself may comprise a siloxane-based film that is less hard than the basecoat, adheres well to the basecoat, and may include any exposed reinforcing particles or portions thereof protruding from the basecoat. Any of the overcoat compositions may be combined with any of the basecoat compositions described above.

The present coating compositions generally include a basecoat and an overcoat which, as described further below, may be initially formulated or provided as separate liquid compositions which are sequentially applied and cured. The basecoat may be applied directly to the surface of the substrate article or alternatively, may be applied over one or more underlying coatings, or undercoats such as a primer which is applied directly to the outer surface of the substrate article, with the basecoat applied over the primer. The overcoat is applied to, or over, the basecoat, either in direct contact with the basecoat or over an intervening midcoat. The overcoat may be a topcoat, in which case the overcoat is the exterior-most or exteriorly exposed coating of the coating system.

### V. Basecoat

The basecoat of the composition of the present disclosure may include at least one of an organosiloxane basecoat, an organic polymer basecoat, and a silicon resin basecoat. Each of these basecoats is described further below. Regardless of the chemistry employed to form the basecoat of the composition, certain characteristics may be used to describe the basecoat, such as its hardness and resistance to deformation. For example, the present basecoats may have one of a Martens hardness of at least 0.2 GPa and/or an elastic modulus of at least 5 GPa, as determined by DIN ISO 14577 1-3 and as described further below. The basecoat may have both a Martens hardness of at least 0.2 GPa and an elastic modulus of at least 5 GPa, as determined by DIN ISO 14577 1-3.

The basecoat may include reinforcing particles. The reinforcing particles may be partially or fully embedded in the basecoat and may reinforce the coating composition by assisting in the deflections of mechanical forces acting on the composition.

a. Organosiloxane Basecoats

As discussed above, the organosiloxane basecoat may comprise organosiloxane-based solid polymers. The organosiloxane may be present in the composition in an amount of about 10 wt. % or greater, about 15 wt. % or greater, about 20 wt. % or greater, about 25 wt. % or greater, about 30 wt. % or greater, about 35 wt. % or greater, about 40 wt. % or greater, about 45 wt. % or less, about 50 wt. % or less, about 55 wt. % or less, about 60 wt. % or less, about 65 wt. % or less, or any value encompassed by these endpoints, as a percentage of the total basecoat composition weight on a wet weight basis.

The organosiloxane may be present in the composition in an amount of about 20 wt. % or greater, about 25 wt. % or greater, about 30 wt. % or greater, about 35 wt. % or greater, about 40 wt. % or greater, about 45 wt. % or greater, about 50 wt. % or greater, about 55 wt. % or greater, about 60 wt. % or greater, about 65 wt. % or less, about 70 wt. % or less, about 75 wt. % or less, about 80 wt. % or less, about 85 wt. % or less, about 90 wt. % or less, or any value encompassed by these endpoints, as a percentage of the total basecoat composition weight on a dry (solids) weight basis.

The sol-gel basecoat formulations of the present disclosure may also comprise one or more catalysts. Suitable catalysts may include acid catalysts, such as maleic acid, formic acid, acetic acid, oxalic acid, malic acid, hydrochloric acid, boric acid, nitric acid, sulfuric acid, and phytic acid, for example.

The catalyst or catalysts may be present in the composition in an amount of about 0.01 wt. % or greater, about 0.1 wt. % or greater, about 0.5 wt. % or greater, about 1 wt. % or greater, about 2 wt. % or less, about 3 wt. % or less, about 4 wt. % or less, about 5 wt. % or less, or any value encompassed by these endpoints, as a percentage of the total basecoat composition weight on a wet weight basis.

b. Organic Polymer Basecoats

A second type of basecoat composition of the present coating systems is an organic polymer basecoat. The organic polymer may be at least one of polyphenylene sulfide (PPS), polyethersulfone (PES), polyether ether ketone (PEEK), polyphenylsulfone (PPSU), polyamide-imides (PAI), polyetherimides (PEI), polyimide (PI), and combinations thereof.

Properties such as melt points and glass transition temperatures (Tg) may be determined by differential scanning calorimetry (DSC), in which phase change or glass transition may be monitored as a function of temperature in the sample in comparison to a reference sample.

The organic polymer may be a crystalline thermoplastic polymer having a melt point of about 200° C. or greater, about 210° C. or greater, about 220° C. or greater, or about 250° C. or greater, as determined by differential scanning calorimetry (DSC) according to ASTM E794—06(2018), for example.

The organic polymer may be an amorphous thermoplastic polymer having a glass transition temperature (Tg) of about 90° C. or greater, about 100° C. or greater, about 120° C. or greater, about 150° C. or greater, about 170° C. or greater, or about 200° C. or greater, as determined by differential scanning calorimetry (DSC) according to ASTM E1356—08(2014), for example.

The organic polymer may be a thermosetting polymer having a heat deflection/distortion temperature (HDT) of about 100° C. or greater, about 120° C. or greater, about 150° C. or greater, about 170° C. or greater, or about 200° C. or greater, as determined by ASTM D648.

The above described properties (high melt point, high glass transition temperature (Tg), and heat deflection/heat distortion temperature (HDT)) may contribute, either individually or in combination, to a coating having a continuous use temperature greater than 200° C.

The organic polymer may be present in the composition in an amount of about 5 wt. % or greater, about 10 wt. % or greater, about 15 wt. % or greater, about 20 wt. % or greater, about 25 wt. % or greater, about 30 wt. % or greater, about 35 wt. % or greater, about 40 wt. % or less, about 45 wt. % or less, about 50 wt. % or less, about 55 wt. % or less, about 60 wt. % or less, or any value encompassed by these endpoints, as a percentage of the total basecoat composition weight on a wet weight basis.

The organic polymer may be present in the composition in an amount of about 10 wt. % or greater, about 15 wt. % or greater, about 20 wt. % or greater, about 25 wt. % or greater, about 30 wt. % or greater, about 35 wt. % or greater, about 40 wt. % or greater, about 45 wt. % or greater, about 50 wt. % or greater, about 55 wt. % or less, about 60 wt. % or less, about 65 wt. % or less, about 70 wt. % or less, about 75 wt. % or less, about 80 wt. % or less, about 85 wt. % or less, about 90 wt. % or less, or any value encompassed by these endpoints, as a percentage of the total basecoat composition weight on a dry (solids) weight basis.

The organic polymer may be provided in a solution. Suitable solvents for the solution may include polar aprotic solvents, such as N-methyl pyrrolidone, N-ethyl pyrrolidone, N-butyl pyrrolidone, N,N-dimethyl acetamide, caprolactone (epsilon-lactone), butyrolactone (gamma-lactone), 3-methoxy-N,N-dimethylpropionamide, morpholine, and cyclohexanone, for example.

Alternatively, the organic polymer may be provided as a particle. The organic polymer may be ground using a media mill, such as a ball mill, jar mill, basket mill, or attritor mill, for example, to produce a plurality of granule particles, which are then mixed with one or more of the remaining components as described herein.

The granule particles may be provided as a plurality of particle sizes having a median diameter, or D50, of about 0.5 micron or larger, about 1 micron or larger, about 5 microns or larger, about 10 microns or larger, about 15 microns or larger, about 20 microns or larger, about 25 microns or smaller, about 30 microns or smaller, about 35 microns or smaller, about 40 microns or smaller, about 45 microns or smaller, about 50 microns or smaller, or any value encompassed by these endpoints, as determined by dynamic light scattering.

The organic polymer may be provided as a plurality of particles having a median diameter, or D50, of about 0.5 microns or larger, about 1 micron or larger, about 2 microns or larger, about 5 microns or larger, about 10 microns or smaller, about 20 microns or smaller, about 50 microns or smaller, or any value encompassed by these endpoints. One suitable method for determining median particle size is described in ISO 13320:2009. Further methods for determining the median particle diameter are discussed herein in conjunction with reinforcing particles.

The organic polymer may be provided as a plurality of particles in which 99% of the particles have a particle diameter, or D99, as great as about 100 microns, 75 microns, 60 microns, as little as 50 microns, 40 microns, 30 microns, or less, or within any range defined between any two of the foregoing value. Methods for determining the particle diameter are discussed herein in conjunction with reinforcing particles.

c. Silicon Resin Basecoats

A third type of basecoat composition of the present coating systems is a silicon resin basecoat. Suitable silicon-containing moieties for use in the silicon resin basecoats of the present disclosure may include polymeric silicon resins, which may be linear or branched, terminated or un-terminated. The resins may include hydroxy- and alkoxy-functionalized polysiloxane polymers or copolymers containing RSiO_{3/2} units, R₂SiO units, and R₃SiO_{1/2} units, wherein R is independently alkyl or aryl and the weight percent of hydroxy and/or alkoxy radicals is from 0.5 wt. % to 35 wt. % and the weight percent of silicon dioxide residue following full oxidation is from 45 wt. % to 90 wt. %. Suitable silicon resins may include poly(methylsilsesquioxane), poly(propylsilsequioxane), poly(phenylsilsesquionane), polydimethylsiloxane, vinylmethylsiloxane, trimethylsilyl-terminated polydimethylsiloxane, vinyl-terminated polydimethylsiloxane, and trimethylsilyl-terminated polymethylhydrosiloxane, for example.

The silicon polymer may be present in the composition in an amount of about 20 wt. % or greater, about 25 wt. % or greater, about 30 wt. % or greater, about 35 wt. % or greater, about 40 wt. % or greater, about 45 wt. % or greater, 50 wt. % or greater, about 55 wt. % or less, about 60 wt. % or less, about 65 wt. % or less, about 70 wt. % or less, about 75 wt. % or less, about 80 wt. % or less, about 85 wt. % or less, about 90 wt. % or less, or any value encompassed by these endpoints, as a percentage of the total basecoat composition weight on a wet weight basis.

The silicon polymer may be present in the composition in an amount of about 20 wt. % or greater, about 25 wt. % or greater, about 30 wt. % or greater, about 35 wt. % or greater, about 40 wt. % or greater, about 45 wt. % or greater, 50 wt. % or greater, about 55 wt. % or less, about 60 wt. % or less, about 65 wt. % or less, about 70 wt. % or less, about 75 wt. % or less, about 80 wt. % or less, about 85 wt. % or less, about 90 wt. % or less, or any value encompassed by these endpoints, as a percentage of the total basecoat composition weight on a dry (solids) weight basis.

The silicon resin basecoat formulations of the present disclosure may also comprise one or more catalysts. Suitable catalysts may include metal catalysts, such as platinum-, tin-, zinc-, zirconium-, and cerium-based catalysts, including platinum-cyclovinylmethyl-siloxane complexes, tin ethylhexanoate, zinc ethylhexanoate, zirconium ethylhexanoate, cerium ethylhexanoate, and tin dibutyl laurate, for example.

The catalyst or catalysts may be present in the composition in an amount of 0 wt. %, or about 0.01 wt. % or greater, about 0.1 wt. % or greater, about 0.5 wt. % or greater, about 1 wt. % or greater, about 2 wt. % or greater, about 3 wt. % or greater, about 4 wt. % or greater, about 5 wt. % or less, about 6 wt. % or less, about 7 wt. % or less, about 8 wt. % or less, about 9 wt. % or less, about 10 wt. % or less, or any value encompassed by these endpoints, as a percentage of the total basecoat composition weight on a wet weight basis.

The catalyst or catalysts may be present in the composition in an amount of 0 wt. %, or about 0.1 wt. % or greater, about 0.5 wt. % or greater, about 1 wt. % or greater, about 2 wt. % or greater, about 5 wt. % or greater, about 10 wt. % or less, about 15 wt. % or less, about 20 wt. % or less, or any value encompassed by these endpoints, as a percentage of the total basecoat composition weight on a dry (solids) weight basis.

d. Reinforcing Particles

The composition may additionally comprise one or more reinforcing particles, also referred to as fillers. Exemplary reinforcing particles include silicas, aluminas, titanias, zirconias, wollastonite, quartz, silicon carbide, fluorspar, christobalite, synthetic diamonds, topaz, orthoclase, apatite, and short glass fibers.

The reinforcing particles may have a Mohs hardness of 4 or higher as determined by ASTM E92-17. Alternatively, the hardness of the reinforcing particles may be described using Knoop hardness. The reinforcing particles may have a Knoop hardness of 160 kg/m² or greater as determined by ASTM C1326.

The reinforcing particles may also be described by their size. The particle size may be determined by dynamic light scattering. Alternatively, the particle size may be determined by scanning electron microscopy (SEM) analysis. A visual examination of a scanning electron microscopy (SEM) micrograph is conducted, in which the diameters of the particles in the image may be measured following magnification of the image as measured in cross section, with no size correction. From these measurements, the average primary particle size may then be calculated. The primary particle size is defined herein as the smallest diameter sphere that will completely enclose the particle. Thus, the primary particle size refers to the size of individual particles rather than agglomerations of two or more particles. To ensure a sufficient representation of possible particle sizes, a sample of 20 particles or more, 50 particles or more, 70 particles or more, or 100 particles or more may be measured.

The reinforcing particles may have an average particle size of about 5 micrometers or larger, about 10 micrometers or larger, about 15 micrometers or larger, about 20 micrometers or larger, about 25 micrometers or later, about 30 micrometers or larger, about 35 micrometers or larger, about 40 micrometers or larger, about 45 micrometers or larger, about 50 micrometers or larger, 55 micrometers or smaller, 60 micrometers or smaller, 65 micrometers or smaller, 70 micrometers or smaller, 75 micrometers or smaller, 80 micrometers or smaller, 85 micrometers or smaller, 90 micrometers or smaller, 95 micrometers or smaller, 100 micrometers or smaller, or any value encompassed by these endpoints, as determined by dynamic light scattering.

The reinforcing particles may have a variety of shapes. For example, the reinforcing particles may be spherical, oval, or platelet shaped. The reinforcing particles may also be defined by their size ratio. The size ratio is defined herein as the ratio of the particle size “p” to the thickness of the basecoat “t”. The size ratio may be determined by cutting a cross section of the coating and polishing it using a lapping technique so that it is observable by scanning electron microscopy (SEM) at a magnification of between 500× and 5000×. Dimensional imaging may be performed by measuring the particle size with the smallest circle circumscribed to the particle and measuring the film thickness of the coating by point-to-point measurements between the observable substrate surface and the coating surface.

The ratio of the thickness of the basecoat to the particle is about 0.5:1.0 or greater, about 0.6:1.0 or greater, about 0.7:1.0 or greater, about 0.8:1.0 or greater, about 0.9:1.0 or greater, about 1.0:1.0 or greater, about 1.1:1.0 or greater, about 1.2:1.0 or greater, about 1.3:1.0 or less, about 1.4:1.0 or less, about 1.5:1.0 of less, about 1.7:1.0 or less, about 1.8:1.0 or less, about 1.9:1.0 or less, about 2.0:1.0 or less, about 2.1:1.0 or less, about 2.2:1.0 or less, or any value encompassed by these endpoints as determined by scanning electron microscopy cross-section analysis.

The number of reinforcing particles present in the basecoat is about 3 or more, about 4 or more, about 5 or more, about 6 or fewer, about 7 or fewer, about 8 or fewer, about 9 or fewer, or about 10 or fewer, per 1 centimeter length of a transverse cross section of the basecoat as determined by scanning electron microscopy cross section analysis.

The one or more reinforcing particles may be present in the composition in an amount of about 3 wt. % or greater, about 4 wt. % or greater, about 5 wt. % or greater, about 6 wt. % or less, about 7 wt. % or less, about 8 wt. % or less, about 9 wt. % or less, about 10 wt. % or less, or any value encompassed by these endpoints, as a percentage of the total basecoat composition weight on a wet weight basis.

The one or more reinforcing particles may be present in the composition in an amount of about 5 wt. % or greater, about 10 wt. % or greater, about 15 wt. % or greater, about 20 wt. % or less, about 25 wt. % or less, about 30 wt. %, or any value encompassed by these endpoints, as a percentage of the total basecoat composition weight on a dry (solids) weight basis.

e. Additives

The basecoats of the present disclosure may further comprise one or more nanoparticle additives such as silica, titania, zirconia, and alumina, for example. Without wishing to be bound by theory, the nanoparticles may act as seeds for gel growth in the sol-gel process. The nanoparticles may also contribute to increase both hardness and cohesion of the sol-gel composition, while preserving transparency and gloss. When used in conjunction with other basecoat compositions, such as the organic polymer and silicon resin basecoats of the present disclosure, the nanoparticle additives may be used as co-binders. In these instances, the nanoparticles may impart adhesion and cohesion, and improve critical film thickness in the coating.

The nanoparticle additives may have a particle size of about 10 nm or larger, about 20 nm or larger, about 50 nm or larger, about 75 nm or larger, about 100 nm or larger, about 150 nm or larger, about 200 nm or smaller, about 250 nm or smaller, about 300 nm or smaller, about 350 nm or smaller, about 400 nm or smaller, about 450 nm or smaller, about 500 nm or smaller, or any value encompassed by these endpoints.

The nanoparticle additives may be present in the composition in an amount of about 0 wt. % or greater, about 1 wt. % or greater, about 5 wt. % or greater, about 10 wt. % or greater, about 15 wt. % or greater, about 20 wt. % or less, about 25 wt. % or less, about 30 wt. % or less, about 35 wt. % or less, or any value encompassed by these endpoints, as a percentage of the total basecoat composition weight on a wet weight basis.

The nanoparticle additives may be present in the composition in an amount of about 0 wt. % or greater, about 1 wt. % or greater, about 5 wt. % or greater, about 10 wt. % or greater, about 15 wt. % or greater, about 20 wt. % or greater, about 25 wt. % or greater, about 30 wt. % or greater, about 35 wt. % or greater, about 40 wt. % or less, about 45 wt. % or less, about 50 wt. % or less, about 55 wt. % or less, about 60 wt. % or less, or any value encompassed by these endpoints, as a percentage of the total composition weight on a dry (solids) weight basis.

The basecoats of the present disclosure may further comprise one or more additives such as thickeners, surfactants, thinners, extenders, and pigments. Suitable additives may include talc, mica, barium sulfate, associative polyurethane thickeners, alkali-swellable acrylic thickeners, bentone clays, non-ionic surfactants such as alkyl ethoxylates, acetylenic surfactants, siloxane polyether-based surfactants, fatty acid-, silica-, and siloxane-based defoamers, and the like. These additives may be present in the basecoat in an amount of about 0.1 wt. % or greater, about 1 wt. % or greater, about 5 wt. % or greater, about 10 wt. % or greater, about 20 wt. % or greater, about 30 wt. % or less, about 40 wt. % or less, about 50 wt. % or less, about 60 wt. % or less, or any value encompassed by these endpoints, as a percentage of the total basecoat composition weight on a wet weight basis.

These additives may be present in the basecoat in an amount of about 2 wt. % or greater, about 5 wt. % or greater, about 10 wt. % or greater, about 20 wt. % or greater, about 30 wt. % or greater, about 40 wt. % or greater, about 50 wt. % or less, about 60 wt. % or less, about 70 wt. % or less, about 80 wt. % or less, or any value encompassed by these endpoints, as a percentage of the total basecoat composition weight on a dry (solids) weight basis.

Any of the basecoats described above may be used in the coating compositions of the present disclosure with any of the overcoat compositions described below.

### VI. Overcoats

As discussed above, the overcoat provides desired nonstick characteristics for the coatings of the present disclosure while the basecoat provides mechanical strength. The overcoats of the present disclosure may comprise siloxane films. The siloxane films may be formed through at least one of a hydrosilylation reaction, a dehydrogenative coupling, or a polycondensation reaction.

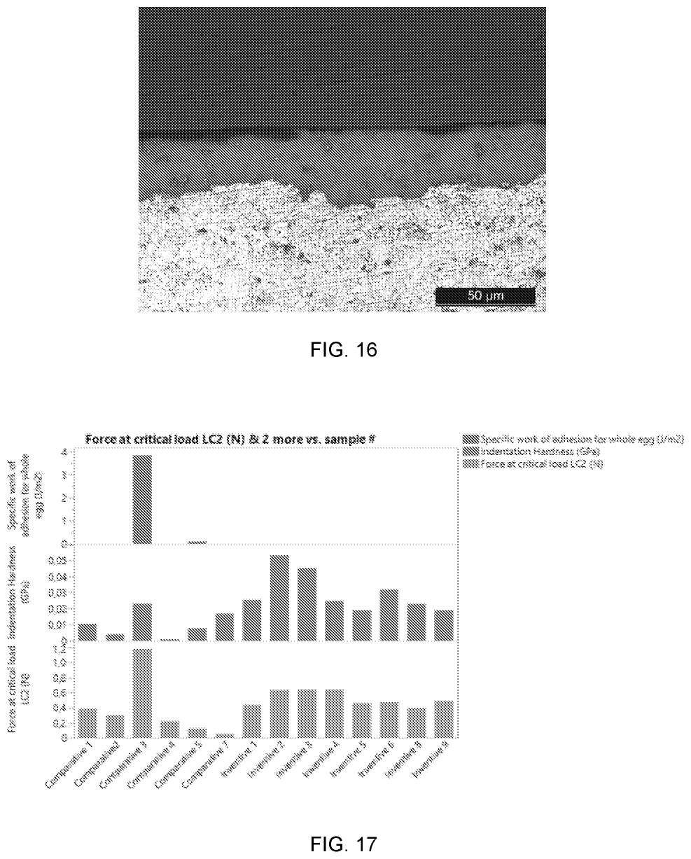

Some known coatings may derive nonstick properties from the inclusion of silicon oil. This type of coating may be non-homogenous in that the silicon oil may separate from the remainder of the coating. FIG. 16 shows an example of this type of coating, in which the coating is applied to a substrate, the coating having a principal phase and a thin superficial layer that is separated from, or not homogeneous with, the principal phase. In this manner, in a scanning electron microscopy (SEM) cross section, more than one morphology is observed or, stated otherwise, the chemical composition visibly changes and/or a compositional gradient in the cross section is observed.

In contrast to the coating depicted in FIG. 16, the siloxane film overcoats of the present disclosure may be homogeneous, meaning that the chemical composition of the overcoat may be substantially the same throughout the cross section of the overcoat. Stated alternatively, when observed at a microscopic level, it may be that the siloxane film of the overcoat does not have a compositional gradient throughout the cross section of the overcoat. For example, in a scanning electron microscopy (SEM) cross section, only one morphology is observed. Morphology, as used herein, means the distribution of phases within a given system.

a. Hydrosilylation

Silicone elastomers have been used in non-stick coatings for industrial bakeware due to their ability to provide good non-stick and high film build. However, silicone elastomers in prior coatings tended to have weak scratch resistance and low hardness and therefore typically included particulate fillers. However, the use of fillers may not result in an increase in mechanical properties due to the lack of cohesion of the elastomer itself. Additionally, increases in crosslink density of the elastomers may provide a harder film but at the expense of non-stick and stress cracking of the film.

A first type of overcoat composition of the present coating systems is siloxane films formed via hydrosilylation reactions, which provide a silicone elastomer film composition that maximizes non-stick properties, allows a high film build, and also provides good hardness and scratch resistance in a transparent coating. Further, as described below and in the Examples, the superior mechanical properties of these overcoats are not compromised by a decrease in the initial non-stick properties of the coating, and the overcoats also have improved stress cracking resistance, allowing a better film integrity for a clear coat.

The hydrosilylation reaction may occur between vinyl-substituted organosiloxanes and hydride-substituted organosiloxanes as shown below in Scheme 1:

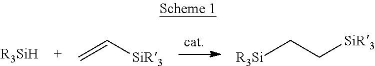

wherein R and R′ may each be alkyl, aryl, or siloxy.

These overcoats generally include a base binder resin in the form of a silicone elastomer, a co-binder, and an inorganic filler characterized by an aspect ratio such as acicular or platelet.

The base binder resin is formed via a hydrosilylation reaction, such as that set forth above in Scheme 1, between a vinyl-terminated polydimethyl siloxane and a polydimethyl siloxane including hydride groups, the reaction optionally catalyzed with a catalyst.

Precursors for hydrosilylation reactions may include polymeric components. Suitable polymeric components may be linear or branched. The polymeric components may be terminated and/or substituted. Examples of suitable precursors may include polymethylhydrosiloxane, vinylmethylsiloxane, polydiphenylsiloxane, vinyl-terminated polydimethylsiloxane, vinyl-terminated diphenylsiloxane-dimethylsiloxane copolymers, hydride-terminated polydimethylsiloxanes, hydride-terminated polyphenylmethylsiloxane, cyclic vinylmethylsiloxane, vinyl MQ resin, trimethylsilyl-terminated polymethylhydrosiloxane, trimethylsiloxane-terminated methylhydrosiloxane-dimethylsiloxane copolymer, hydride MQ resin, and the like, including combinations thereof.

One suitable precursor is a linear vinyl-terminated polydimethyl siloxane (PDMS), such as those set forth in the table below.

| | | | Viscosity | Molecular |
|---|---|---|---|---|
| Trade name | Chemical description | CAS# | (cSt) | weight (g/mol) |
| DMS-V-31 | Vinyl terminated PDMS | 68083-19-2 | 1000 | 12000 |
| DMS-V35 | Vinyl terminated PDMS | 68083-19-2 | 5000 | 49500 |
| Silmer VIN10000 | Vinyl terminated PDMS | 68083-19-2 | 10000 | 5400 |

In these vinyl-terminated polydimethyl siloxanes, the molecular weight is proportional to the viscosity.

The viscosity of the vinyl-terminated polydimethyl siloxane may be from 500 cSt, 1,000 cSt, 2,000 cSt, or 3,500 cSt, to 5,000 cSt, 8,000 cSt, 10,000 cSt, 12,000 cSt, 20,000 cSt, or 50,000 cSt, or any value encompassed by any two of the foregoing as endpoints. The viscosity may be determined by ASTM D445-21e1, direct measurement with a Brookfield viscometer accordingly to methods such as ISO 3219.

The molecular weight of the vinyl-terminated polydimethyl siloxane may be from 10,000 g/mol, 20,000 g/mol or 30,000 g/mol to 40,000 g/mol, 50,000 g/mol, 60,000 g/mol or 100 g/mol, or any value encompassed by any two of the foregoing as endpoints. Molecular weight, herein expressed as weight average, may be determined by gel permeation chromatography (GPC) analysis.

The vinyl-terminated polydimethyl siloxane may be present in an amount from 35 wt. %, 40 wt. %, 45 wt. % to 55 wt. %, 60 wt. %, 65%, or any value encompassed by any two of the foregoing as endpoints, based on the total solids weight of the overcoat composition.

The vinyl terminated polydimethyl siloxane may be reacted with a polydimethylsiloxane including hydride groups.

The hydride content of polydimethylsiloxane including hydride groups may be from 15 mol %, 30 mol %, or 35 mol % to 45 mol %, 50 mol %, or 60 mol % or any value encompassed by any two of the foregoing as endpoints.

The viscosity of the polydimethylsiloxane including hydride groups may be from 20 cSt or 25 cSt to 35 cSt or 40 cSt, or any value encompassed by any two of the foregoing as endpoints. The viscosity may be determined by Brookfield viscometer according to methods such as ISO 3219.

The molecular weight of the polydimethylsiloxane including hydride groups may be from 1,500 g/mol, 1,750 g/mol or 1,900 g/mol to 2,000 g/mol, 2,250 g/mol, or 2,500 g/mol or any value encompassed by any two of the foregoing as endpoints. Molecular weight, herein expressed as weight average, may be determined by gel permeation chromatography (GPC) analysis.

One suitable polydimethylsiloxane including hydride groups is a methylhydrosiloxane-dimethylsiloxane copolymer terminated with trimethylsiloxane groups (CAS #68037-59-2) having a viscosity of 25-35 cSt, a molecular weight of 1900-2000, and 25-35 mol % hydride groups. The polydimethyl siloxane including hydride groups may be present in an amount from 2 wt. %, 5 wt. %, 10 wt. %, 20 wt. %, 25 wt. %, or 27.5 wt. % to 32.5 wt. %, 35 wt. %, or 40%, or any value encompassed by any two of the foregoing as endpoints, based on the total solids weight of the overcoat composition.

The molar equivalent ratio of vinyl-substituted precursors to hydride-substituted precursors may be about 0.5:1.0 or greater, about 0.8:1.0 or greater, about 0.9:1.0 or greater, about 1.0:1.0 or greater, about 1.1:1.0 or greater, about 1.2:1.0 or less, about 1.3:1.0 or less, about 1.4:1.0 or less, about 1.5:1.0 or less, or any value encompassed by these endpoints.

The precursors may be present in the basecoat composition in an amount of about 40 wt. % or greater, about 45 wt. % or greater, about 50 wt. % or greater, about 55 wt. % or greater, about 60 wt. % or greater, about 65 wt. % or greater, about 70 wt. % or less, about 75 wt. % or less, about 80 wt. % or less, about 85 wt. % or less, about 90 wt. % or less, about 95 wt. % or less, about 100 wt. % or less, or any value encompassed by these endpoints, of the total weight of the basecoat composition on a wet weight basis.

The hydrosilylation reaction may be catalyzed using a suitable catalyst such as platinum, and suitable platinum-based catalysts include the Karstedt catalyst and the Ashby catalyst, each shown below.

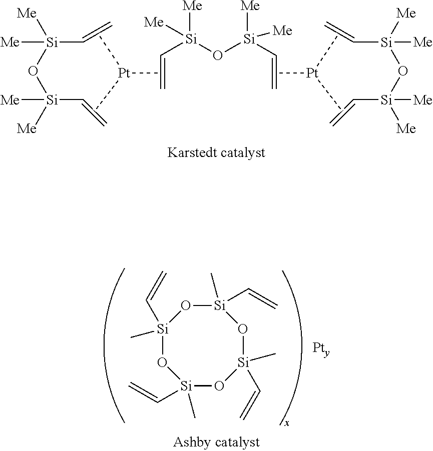

These catalysts may be provided in solution, and are highly stable, providing a long pot life with rapid curing at elevated temperatures. The catalyst may be present in relatively small amounts, such as from 1 ppm to 50 ppm.

The coating may further include an oligomer co-binder to increase crosslinking between the foregoing vinyl-substituted and hydride-substituted precursors, which has been found to increase scratch resistance of the coating.

The co-binder may be a linear PDMS with vinyl functionality along the chain, a cyclic siloxane ring with vinyl functionality, a MQ resin with vinyl functionality, or a VQ resin. Suitable co-binders are set forth in the table below.

| | | | | Molecular | Wt. % | |
|---|---|---|---|---|---|---|
| Trade | | | Viscosity | weight | vinyl | |
| name | Chemical description | Meq/g | (cSt) | (g/mol) | groups | Structure |
| VDT- 431 | VinylMe-DMS copolymer (4.0-5.0% vinylmethylsiloxane- dimethylsiloxane copolymer, trimeth- ylsiloxy terminated) | 0.6 | 800-1200 | 28,000 | 4.5 | 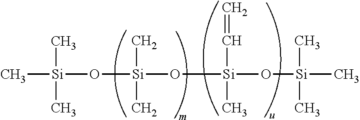 |
| VDT- 731 | VinylMe-DMS copolymer (7.0-8.0% vinylmethylsiloxane- dimethylsiloxane copolymer, trimeth- ylsiloxy terminated) | 1 | 800-1200 | 28,000 | 7.5 | 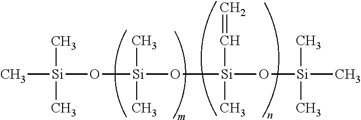 |
| Silmer VIN J10 | VinylMe-DMS copolymer (1% vinylmethylsiloxane- dimethylsiloxane copolymer, trimeth- ylsiloxy terminated) | 1.18 | 160 (cP) | 7100 | 3.19 | 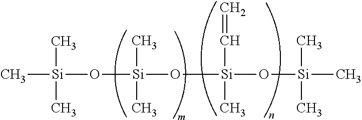 |
| VMS- 005 | VinylMe homopolymer (vinyl- methylsiloxane) | — | 3-7 | 258-431 | — | 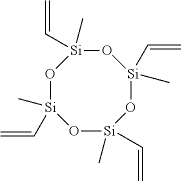 [SMILES: C=C[Si]1(C)O[Si](C)(C=C)O[Si](C)(C=C)O[Si](C)(C=C)O1] |
| Silmer VQ20 | VQ resin | Vinyl Q resin | 1200 (cP) | — | 12 | 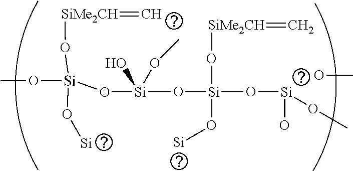 |

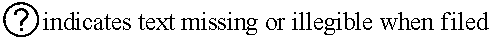

The viscosity of the co-binder may be from 50 cSt, 100 cSt, 000 cSt, or 350 cSt, to 500 cSt, 800 cSt, 1000 cSt, or 1200 cSt, or 2500 cSt or 5000 cSt or any value encompassed by any two of the foregoing as endpoints. The viscosity may be determined by ASTM d445-21.

The molecular weight may be from 5,000 g/mol, 10,000 g/mol or 15,000 g/mol to 20,000 g/mol, 30,000 g/mol, or 40,000 g/mol or any value encompassed by any two of the foregoing as endpoints. Molecular weight, herein expressed as weight average, may be determined by gel permeation chromatography (GPC) analysis.

Advantageously, the co-binder may be a vinyl “Q” resing or VQ resin of an organopolysixloxane expressed by the average unit formula:

[(CH₂═CH)(R)₂SiO_{0.5}]ᵤ[(R)₃SiO_{0.5}]ᵥ[SiO₂]w
wherein R identifies a methyl radical and u, v and w are the mole fractions of the respective siloxane units and wherein (u+v)/w is from 0.5 to 2.

The co-binder may be present in an amount from 0.5 wt. %, 5 wt. %, 12 wt. %, 15 wt. %, or 17.5 wt. % to 22.5 wt. %, 25 wt. %, or 30%, or any value encompassed by any two of the foregoing as endpoints, based on the total solids weight of the overcoat composition.

Suitable fillers for the coatings may include those having an elongate aspect ratio, such as platelets or short fibers. It has been found that fillers with an aspect ratio help to preserve the mechanical integrity of the coating, and increase the indentation modulus without affecting surface properties, food fouling release or gloss.

The fillers may be collectively present in an amount from 1 wt. %, 2 wt. %, 3 wt. % to 4 wt. %, 5 wt. %, 7.5%, or any value encompassed by any two of the foregoing as endpoints, based on the total solids weight of the overcoat composition.

The fillers may have a median diameter, or d50, of about 1 micron or greater, about 2 microns or greater, about 5 microns or greater, about 10 microns or greater, about 20 microns or less, about 30 microns or less, about 40 microns or less, about 50 microns or less, 60 microns or less, or any range or value encompassed by these endpoints.

The aspect ratio of the filler particles can be 3:1 or greater, 5:1 or greater, 10:1 or greater, 20:1 or greater, 50:1 or greater, 100:1 or greater, 200:1 or greater, 500:1 or greater, 1000:1 or greater, 2000:1 or greater, 5000:1 or greater, or 10,000:1 or greater.

The filler may be a wollastonite (calcium silicate, CaSiO₃) such as Imerys Nyglos 4W, Nyglos 8, Nyglos 9000, or a Muscovite mica.

Other inorganic fillers include kaolin, potassium titanate, talc, plastorite, perlescent mica, glass platelets, hexagonal boron nitride, graphite, graphene, graphene oxide, molybdenum disulfide, basalt short fibres, alumina whiskers, glass short fibres, and hydroxyapatite whiskers.

b. Dehydrogenative Coupling

A second type of overcoat composition of the present coating systems is siloxane films formed via dehydrogenative coupling. The dehydrogenative couplings may occur between hydride-substituted organosiloxanes and hydroxy-substituted organosiloxanes, as shown below in Scheme 2:

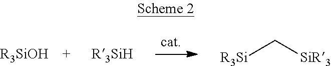

wherein R may be alkyl, aryl, or alkoxy, and R′ may be alkyl, aryl, alkoxy, or siloxy.

Precursors for dehydrogenative coupling reactions may include polymeric components. Suitable polymeric components may linear or branched. The polymeric components may be terminated and/or substituted. Examples of suitable precursors may include polymethylhydrosiloxane, hydride-terminated polydimethylsiloxanes, hydride-terminated polyphenylmethylsiloxane, hydroxyl-terminated polydimethylsiloxane, silanol-terminated polydimethylsiloxane, silanol-terminated polyphenylsiloxane, silanol-terminated diphenylsiloxane-dimethylsiloxane copolymers, trimethylsilyl-termianted polymethylhydrosiloxane, trimethylsiloxane-terminated methylhydrosiloxane-dimethylsiloxane copolymers, hydride MQ resin, hydroxide MQ resin, and the like, including combinations thereof.

The molar equivalent ratio of hydride-substituted precursors to hydroxyl-substituted precursors may be about 0.8:1.0 or greater, about 0.9:1.0 or greater, about 1.0:1.0 or greater, about 1.1:1.0 or greater, about 1.2:1.0 or less, about 1.3:1.0 or less, about 1.4:1.0 or less, about 1.5:1.0 or less, or any value encompassed by these endpoints.

The precursors may be present in the basecoat composition in an amount of about 40 wt. % or greater, about 45 wt. % or greater, about 50 wt. % or greater, about 55 wt. % or greater, about 60 wt. % or greater, about 65 wt. % or greater, about 70 wt. % or greater, about 75 wt. % or less, about 80 wt. % or less, about 85 wt. % or less, about 90 wt. % or less, about 95 wt. % or less, about 100 wt. % or less, or any value encompassed by these endpoints, based on the total weight of the basecoat composition on a wet weight basis.

c. Polycondensation

A third type of overcoat composition of the present coating systems is siloxane films formed via polycondensation. The polycondensation reaction may occur between two silanols, as shown below in Scheme 3:

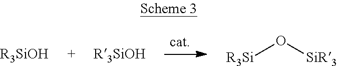

wherein R may be alkyl, aryl, or siloxy; and R′ may be alkyl, aryl, or siloxy.

Alternatively, the polycondensation reaction may occur between a silanol and an of alkoxysilane, as shown below in Scheme 4:

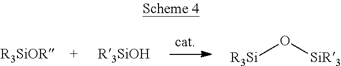

wherein R and R′ may be alkyl, acetoxy, aryl, alkynyl, or siloxy, and R″ may be alkyl.

Precursors for polycondensation reactions may include polymeric components. Suitable polymeric components may be linear or branched. The polymeric components may be terminated and/or substituted. Suitable precursors for use in the polycondensation reactions of the present disclosure may include hydroxyl-terminated polydimethylsiloxane, silanol-terminated polydimethylsiloxane, silanol-terminated polyphenylsiloxane, silanol-terminated diphenylsiloxane-dimethylsiloxane copolymers, poly(methylsilsesquioxane), poly(propylsilsesquioxane), poly(phenylsilsesquioxane), poly(2-acetoxyethylsilsesquioxane), organo-modified alkoxy-silanes and their oligomers, and the like, including combinations thereof.

d. Catalysts

One or more catalysts may be used in the hydrosilylation reaction. Suitable catalysts for hydrosilylation may include transition metal-based catalysts, such as tin-, titanium-, platinum- and palladium-, rhodium-, and ruthenium-based catalysts, for example, as well as organoperoxides, such as dicumyl peroxide, for example.

One or more catalysts may be used in the dehydrogenative coupling reaction. Suitable catalysts may include transition metal-based catalysts, such as tin-, rhodium-, ruthenium-, gold-, copper-, zinc-, zirconium-, titanium-, platinum-, and palladium-based catalysts, for example.

One or more catalysts may be used in the polycondensation reaction. Suitable catalysts may include protic acids, Lewis acids, or bases. Suitable catalysts may also include transition metal catalysts, such as zinc-, zirconium-, tin-, and titanium-based catalysts.

The catalyst may be present in the composition in an amount of about 0.005 wt. % or greater, about 0.05 wt. % or greater, about 0.1 wt. % or greater, about 0.5 wt. % or greater, about 1 wt. % or greater, about 2 wt. % or greater, about 3 wt. % or greater, about 4 wt. % or less, about 5 wt. % or less, about 6 wt. % or less, about 7 wt. % or less, about 8 wt. % or less, about 9 wt. % or less, about 10 wt. % or less, or any value encompassed by these endpoints, as a percentage of the total overcoat composition weight on a wet weight basis.

The catalyst may be present in the composition in an amount of about 0.005 wt. % or greater, about 0.05 wt. % or greater, about 0.1 wt. % or greater, about 0.5 wt. % or greater, about 1 wt. % or greater, about 2 wt. % or greater, about 3 wt. % or greater, about 4 wt. % or less, about 5 wt. % or less, about 6 wt. % or less, about 7 wt. % or less, about 8 wt. % or less, about 9 wt. % or less, about 10 wt. % or less, or any value encompassed by these endpoints, as a percentage of the total overcoat composition weight on a dry (solids) weight basis.

Any of these overcoat compositions may be used in the coating compositions of the present disclosure with any of the basecoat compositions described above.

### VII. Solvents

The composition may include one or more solvents. Exemplary solvents include water, alcohols such as C₁-C₈ alcohols including methanol, ethanol, isopropanol, and t-butanol, C₂-C₈ ketones including acetone, C₂-C₂₀ ethers including dipropylene glycol methyl ether and other protic or non-protic solvents like dimethylsulfoxide or N-methylpyrrolidone.

The solvent may be present in the composition in an amount of about 0 wt. % or greater, about 1 wt. % or greater, about 5 wt. % or greater, about 10 wt. % or greater, about 15 wt. % or greater, about 20 wt. % or greater, about 25 wt. % or greater, about 30 wt. % or greater, about 35 wt. % or less, about 40 wt. % or less, about 45 wt. % or less, about 50 wt. % or less, about 55 wt. % or less, about 60 wt. % or less, about 65 wt. % or less, about 70 wt. % or less, or any value encompassed by these endpoints, as a percentage of the total coating composition weight on a wet weight basis.

After the coating has been applied and cured, the total coating composition may be substantially free of solvent. In other words, the solvent may be present in the composition in an amount of about 1 wt. % or less, about 0.5 wt. % or less, or about 0.1 wt. % or less of the total coating composition weight on a dry (solids) weight basis.

### VIII. Methods of Forming Coatings

a. Mixing of Components

The coating composition is formed by separately formulating the basecoat composition and the overcoat composition. Each of these may be formulated by mixing their respective components. Once the basecoat and overcoat compositions have been mixed, the compositions may be separately applied to the substrate to ultimately form the coating composition.

In one aspect, the components may be mixed together prior to applying the resulting coating composition to a substrate, and one of ordinary skill in the art may determine the point at which mixing is performed prior to application depending on the extent of hydrolysis and condensation of the silane reactants that is desired prior to application of the coating composition to the substrate. In other aspects, subsets of the components may be prepared with each subset including components that are not reactive with other components within each subset, with two or more subsets of the components being combined prior to applying the resulting composition to the substrate.

b. Flashing

After the basecoat composition is applied to the substrate, the resulting coating may be flash heated. The coating may be flash heated at a temperature of about 80° C. or higher, about 100° C. or higher, about 120° C. or higher, about 140° C. or higher, about 150° C. of lower, about 170° C. or lower, about 190° C. or lower, about 200° C. or lower, or any value encompassed by these endpoints.

The coating may be flash heated for a period of time of about 1 minute or more, about 2 minutes or more, about 5 minutes or more, about 8 minutes or more, about 10 minutes or less, about 12 minutes or less, about 15 minutes or less, about 18 minutes or less, about 20 minutes or less, or any value encompassed by these endpoints.

Following flash heating of the basecoat, the basecoat may be cured as described below prior to the application of the overcoat. Following application of the overcoat, the resulting coating may be flash heated at a temperature of about 80° C. or higher, about 100° C. or higher, about 120° C. or higher, about 140° C. or higher, about 150° C. of lower, about 170° C. or lower, about 190° C. or lower, about 200° C. or lower, or any value encompassed by these endpoints.

The coating may be flash heated for a period of time of about 1 minute or more, about 2 minutes or more, about 5 minutes or more, about 8 minutes or more, about 10 minutes or less, about 12 minutes or less, about 15 minutes or less, about 18 minutes or less, about 20 minutes or less, or any value encompassed by these endpoints.

Alternatively, the overcoat may be applied to the basecoat prior to curing. In this case, following the application of the overcoat, the resulting coating may be flash heated at a temperature of about 80° C. or higher, about 100° C. or higher, about 120° C. or higher, about 140° C. or higher, about 150° C. of lower, about 170° C. or lower, about 190° C. or lower, about 200° C. or lower, or any value encompassed by these endpoints.

The coating may be flash heated for a period of time of about 1 minute or more, about 2 minutes or more, about 5 minutes or more, about 8 minutes or more, about 10 minutes or less, about 12 minutes or less, about 15 minutes or less, about 18 minutes or less, about 20 minutes or less, or any value encompassed by these endpoints.

Alternatively, the overcoat may be applied to the basecoat prior to flash heating and curing the basecoat. The overcoat and basecoat may then be flash heated and cured concurrently. In this case, following the application of the overcoat and basecoat, the resulting coating may be flash heated at a temperature of about 80° C. or higher, about 100° C. or higher, about 120° C. or higher, about 140° C. or higher, about 150° C. of lower, about 170° C. or lower, about 190° C. or lower, about 200° C. or lower, or any value encompassed by these endpoints.

The coating may be flash heated for a period of time of about 1 minute or more, about 2 minutes or more, about 5 minutes or more, about 8 minutes or more, about 10 minutes or less, about 12 minutes or less, about 15 minutes or less, about 18 minutes or less, about 20 minutes or less, or any value encompassed by these endpoints.

c. Curing

Curing may occur very slowly at room temperature, but curing is typically accomplished at elevated temperatures, such as in a box or tunnel oven.

The basecoat may be cured prior to the application of the overcoat. Following application of the basecoat, the coating may be cured at a temperature of about 200° C. or higher, about 225° C. or higher, 250° C. or higher, about 275° C. or higher, about 300° C. or lower, about 325° C. or lower, about 350° C. or lower, about 400° C. or lower, or any value encompassed by these endpoints.

The coating may be cured for about 5 minutes or longer, about 10 minutes or longer, about 15 minutes or longer, about 20 minutes or longer, about 25 minutes or longer, about 30 minutes or less, about 45 minutes or less, about 60 minutes or less, or any value encompassed by these endpoints.

After the overcoat has been applied and flash heated, the entire coating composition may then be cured. The coating may be cured at a temperature of about 200° C. or higher, about 225° C. or higher, about 250° C. or higher, about 275° C. or higher, about 300° C. or lower, about 325° C. or lower, about 350° C. or lower, about 400° C. or lower, or any value encompassed by these endpoints.

The coating may be cured for about 5 minutes or longer, about 10 minutes or longer, about 15 minutes or longer, about 20 minutes or longer, about 25 minutes or longer, about 30 minutes or less, about 45 minutes or less, about 60 minutes or less, or any value encompassed by these endpoints.

Alternatively, the overcoat may be applied to the basecoat prior to curing the basecoat. In this case, the basecoat may be applied and flash heated, after which the overcoat is applied and flash heating. Once both the basecoat and overcoat have been applied and flash heated, the entire coating composition may be cured.

The coating may be cured at a temperature of about 200° C. or higher, about 225° C. or higher, 250° C. or higher, about 275° C. or higher, about 300° C. or lower, about 325° C. or lower, about 350° C. or lower, about 400° C. or lower, or any value encompassed by these endpoints.

The coating may be cured for about 5 minutes or longer, about 10 minutes or longer, about 15 minutes or longer, about 20 minutes or longer, about 25 minutes or longer, about 30 minutes or less, about 45 minutes or less, about 60 minutes or less, or any value encompassed by these endpoints.

Alternatively, the overcoat may be applied to the basecoat prior to flash heating and curing the basecoat. Following flash heating of the overcoat and basecoat, the coating may be cured.

The coating may be cured at a temperature of about 200° C. or higher, about 225° C. or higher, 250° C. or higher, about 275° C. or higher, about 300° C. or lower, about 325° C. or lower, about 350° C. or lower, about 400° C. or lower, or any value encompassed by these endpoints.

The coating may be cured for about 5 minutes or longer, about 10 minutes or longer, about 15 minutes or longer, about 20 minutes or longer, about 25 minutes or longer, about 30 minutes or less, about 45 minutes or less, about 60 minutes or less, or any value encompassed by these endpoints.

### IX. Coating Properties

As discussed below, the basecoat, overcoat, or entire coating may be characterized by hardness, resistance to deformation, abrasion and scratch resistance, impact resistance, chemical resistance, and resistance to thermal degradation, for example. Each of these characteristics is described in further detail below.

a. Basecoat Properties

The basecoats of the present disclosure may have a minimum effective Martens hardness of 0.2 GPa or higher, 0.3 GPa or higher, 0.4 GPa or higher, 0.5 GPa or higher, or 0.6 GPa or higher as determined by nano-indentation according to DIN ISO 14577 1-3.

The basecoats of the present disclosure may have an elastic modulus of 5 GPa or higher, 7 GPa or higher, 9 GPa or higher, 10 GPa or higher, or 12 GPa or higher as determined by the methods described in ISO 14577-1:2015.

The coating may include the siloxane matrix, the organic polymer and an inorganic reinforcing particle, illustratively a hard inorganic reinforcing particle such as silicon carbide. Without wishing to be bound by theory, it is possible that the inclusion of hard inorganic reinforcing particles increases the abrasion resistance by deflecting forces applied to the overcoat.

The basecoats of the present disclosure may be free of fluoropolymers. In other words, the basecoats of the present disclosure include fluoropolymers in an amount of 1 wt. % or less, 0.5 wt. % or less, or 0.1 wt. % or less, based on the total weight of the basecoat on a wet weight basis. The basecoats of the present disclosure include fluoropolymers in an amount of 1 wt. % or less, 0.5 wt. % or less, or 0.1 wt. % or less, based on the total weight of the basecoat on a dry (solids) weight basis.

b. Overcoat Properties

The overcoats of the present disclosure may be described by their Martens hardness. Specifically, the overcoats of the present disclosure may have a Martens hardness less than the Martens hardness of the basecoat. For example, the overcoats of the present disclosure may have a Martens hardness of 0.2 GPa or less, 0.1 GPa or less, 0.05 GPa or less, as determined by nano-indentation according to DIN ISO 14577 1-3.

The siloxane film overcoats of the present disclosure may be homogeneous, meaning that the chemical composition of the overcoat may be substantially the same throughout the cross section of the overcoat. Stated alternatively, the siloxane film overcoats of the present disclosure may have no compositional gradient throughout a cross section of the overcoat.

The siloxane film overcoats of the present disclosure provide high hydrophobicity and good non-stick properties. Hydrophobicity may be determined using contact angle measurements. For example, a contact angle goniometer may be used with ethylene glycol as a medium-polarity testing fluid. The receding contact angle of a 30 ul droplet of ethylene glycol is measured on the testing surface. Satisfactory nonstick properties may include a receding contact angle of greater than 60 degrees. Satisfactory nonstick properties may further include a roll-off angle (plane tilt to cause displacement of the droplet) of less than 20 degrees. Additional satisfactory nonstick properties may include sufficient cohesion, lack of surface cracking, thermal inertial in the cooking temperature environment, and lack of reactivity with food (as demonstrated in burnt milk and fried egg tests).

The overcoats of the present disclosure may be free of fluoropolymers. In other words, the overcoats of the present disclosure include fluoropolymers in an amount of 1 wt. % or less, 0.5 wt. % or less, or 0.1 wt. % or less, based on the total weight of the overcoat on a wet weight basis. The overcoats of the present disclosure include fluoropolymers in an amount of 1 wt. % or less, 0.5 wt. % or less, or 0.1 wt. % or less, based on the total weight of the overcoat on a dry (solids) weight basis.

The overcoats based on hydrosilylation reactions described above in section VI(a) may have desired properties such as non-stick or release, in combination with hardness of scratch resistance.

These overcoats may have a Martens hardness from 0.003 GPa, 0.005 GPa, or 0.01 GPa to 0.015 GPa, 0.02 GPa, 0.04 GPA, 0.07 GPA, 0.1 GPa. Or 0.15 GPa, or any value encompassed by any two of these values as endpoints. GPa, as determined according to DIN ISO 14577 1-3 using the parameters reported in Table 19 of Example 14 herein for nano-indentation hardness.

As to non-stick or release, these coatings may demonstrate good initial non-stick when tested according Examples 10-12 herein.

c. Properties of the Entire Coating

The coatings in their entirety may be tested to determine their abrasion and scratch resistance, as well as their chemical resistance and resistance to thermal degradation. These characteristics may be used to describe the performance of the entire coating.

Abrasion resistance may be determined by British Standard 7069-1988, EN 12983-1:2004, and taber abrasion tests, for example. As used herein, abrasion resistance is determined using a Dry Reciprocating Abrasion Test (DRAT). This test measures the resistance of coatings to abrasion by a reciprocating Scotch-Brite pad. Scotch-Brite pads are made by 3M Company, Abrasive Systems Division, St Paul, MN 55144-1000. Pads come in grades with varying levels of abrasiveness as follows: Lowest—7445, 7448, 6448, 7447, 6444, 7446, 7440, 5440—Highest. A Scotch-Brite 7447 pad was used and changed every 1000 cycles.

The test subjects a coating to abrasion in a back and forth motion. The test is a measure of the useful life of coatings that have been subjected to scouring and other similar forms of damage caused by cleaning, and is set forth in British Standard 7069-1988 and EN 12983-1:2004.

A test machine capable of holding a 2-inch Scotch-Brite abrasive pad of a specific size to the surface to be tested with a fixed 3 kg force and capable of moving the pad in a back and forth (reciprocating) motion over a distance of 10-15 cm (4 to 6 inches). The force and motion are applied by a free falling, weighted stylus. The machine is equipped with a counter. The coated substrate is secured under the reciprocating pad by firmly fastening with bolts, clamps or tape. The part should be as flat as possible and long enough so that the pad does not run off an edge.

The abrasive pad is then cycled back and forth (one back-and-forth trip is defined as 1-cycle), and the machine was allowed to run for 1000 cycles. After 1000 cycles, the pad was replaced with a fresh pad. The test was run until 10% of the abraded area was exposed to bare metal. The abrasion resistance is reported as number of cycles per thousandth inch of coating (cycles/mil).

Scratch resistance may be determined by using the Scratch Adhesion “Happy Flower” Test (HFT). The test is performed using a pen tip affixed to a balance arm calibrated with a specific weight, and the article is put on a revolving heated turntable (150° C., oil filled). After two hours, the test is stopped, and a score is assigned according to the degree of surface damage.

The inclusion of hard reinforcing particles in the composition increases the scratch resistance of the coating compositions. Specifically, as shown in the Examples below, reinforcing particles with Knoop hardness of 160 kg/m² or greater increase both the abrasion and scratch resistance of the coating. It appears that harder reinforcing particles provide more improvements in resistance than softer particles.

As further shown in the Examples below, it was surprisingly found that smaller reinforcing particles appear to be equally effective as large reinforcing particles in increasing the scratch and abrasion resistance of the coatings. Without wishing to be bound by theory, it is possible that the ability of the basecoat to at least partially immobilize or fully immobilize the reinforcing particles plays a larger role than the size of the particles in conferring scratch and abrasion resistance.

As described further in the Examples below, a strong correlation between the abrasion resistance of the coating and the hardness of the binder resin was found, along with a strong correlation between the scratch resistance of the coating and the elastic modulus of the binder resin.

As mentioned above, chemical resistance may also be measured. As used herein, chemical resistance is determined using 24 hours of exposure to hydrochloric acid, such as a 10 wt. % or 30 wt. % hydrochloric acid solution, or to sodium hydroxide, such as a 10 wt. % sodium hydroxide solution.

The coatings of the present disclosure were deemed to have performed satisfactorily when the scratch resistance measured with the HFT technique has a level of survival greater than 80% of the tested surface, which was observed when the basecoat modulus was greater than 5 GPa. In other words, the elastic recovery work of the basecoat was less than 60 nJ.

Coatings were further deemed to have performed satisfactorily when demonstrating abrasion resistance of at least 200 cycles per micrometer, which was observed when the basecoat demonstrated a Martens hardness of greater than 0.2 GPa, or equivalent measure (Vickers hardness of greater than 20, for example).

Generally, a synergistic effect was observed between the hardness of the basecoat binder and the presence of hard reinforcing particles within said basecoat. Specifically, softer binders are less effective in holding the reinforcing particles in place; thus, their contribution to the mechanical resistance remains negligible even when their size and hardness is varied. Conversely, when the hardness of the basecoat is greater than about 0.2 GPa according to DIN ISO 14577 1-3, the presence of the hard reinforcing particles significantly cooperates to increase the abrasion resistance by one or two orders of magnitude in comparison to compositions without reinforcing particles.

The coatings in their entirety of the present disclosure may be free of fluoropolymers. In other words, the entire coatings of the present disclosure include fluoropolymers in an amount of 1 wt. % or less, 0.5 wt. % or less, or 0.1 wt. % or less, based on the total weight of the entire coating on a wet weight basis. The entire coatings of the present disclosure include fluoropolymers in an amount of 1 wt. % or less, 0.5 wt. % or less, or 0.1 wt. % or less, based on the total weight of the entire coating on a dry (solids) weight basis.

### EXAMPLES

The following non-limiting Examples illustrate various features and characteristics of the present disclosure, which is not to be construed as limited thereto. Throughout the Examples and elsewhere herein, percentages are by weight unless otherwise indicated.

### Example 1: Sol-Gel Basecoat

Four formulations of sol-gel basecoats were prepared according to Table 2, below. In these formulations, the binder was progressively enriched with inorganic reinforcing particles; specifically, platelet-shaped Mica SG and needle-like shaped wollastonite, grade Nyglos 4W.

TABLE 2

| | | Coating | Coating | Coating | Coating |
|---|---|---|---|---|---|
| | | 1 | 2 | 3 | 4 |
| | | (Weight | (Weight | (Weight | (Weight |
| Component | Function | %) | %) | %) | %) |
| Deionized water | thinner | 6.13 | 6.13 | 6.13 | 6.13 |
| Colloidal Silica | co-binder | 24.98 | 24.98 | 24.98 | 24.98 |
| Thickener | thickener | 0.09 | 0.09 | 0.09 | 0.09 |
| Maleic acid | acid catalyst | 0.24 | 0.24 | 0.24 | 0.24 |
| Isopropanol | thinner | 2.76 | 2.76 | 2.76 | 2.76 |
| MTMS | silane film | 25.80 | 25.80 | 25.80 | 25.80 |
| | former | | | | |
| Alumina powder | alumina sub | 6.17 | 5.48 | 5.48 | 5.48 |
| | micronic | | | | |
| | reinforcing | | | | |
| | particles | | | | |
| Isopropanol | thinner | 22.52 | 20.02 | 20.02 | 20.02 |
| Titanium pigment | white pigment | 9.25 | 8.22 | 8.22 | 8.22 |
| Matting agent | matting agent | 1.16 | 1.03 | 1.03 | 1.03 |
| Wetting agent | wetting additive | 0.53 | 0.47 | 0.47 | 0.47 |
| Wetting agent | wetting additive | 0.37 | 0.33 | 0.33 | 0.33 |
| Mica | mica platelet | — | 4.44 | — | — |
| | reinforcing | | | | |
| | particles | | | | |
| Wollastonite | wollastonite | — | — | 4.44 | — |
| | needle-like | | | | |
| | reinforcing | | | | |
| | particles | | | | |
| Silicon Carbide | silicon carbide | — | — | — | 4.44 |
| | reinforcing | | | | |
| Total | | 100.00 | 100.00 | 100.00 | 100.00 |

The formulations were prepared as follows: in each run, a thickener was ground in colloidal silica, and the mixture was thinned with deionized water. Maleic acid and isopropanol were then added, followed by methyltrimethoxysilane (MTMS). The reaction was stirred for two hours. Once the sol-gel reaction occurred, the ground alumina reinforcing particles were added to the mixture along with isopropanol and any desired additives, such as pigments, matting agents, and wetting agents, as shown in Table 2. Finally, the desired reinforcing particles were added, and dispersed via high-speed mixing in the basecoat composition.

The basecoats were then applied to a grit-blasted aluminum substrate, flashed at 100-150° C. for 5-10 minutes, then overcoated with a siloxane overcoat formulation such as those reported in the Examples below. The coated parts were then cured at 300° C. for 20 minutes. The dry coating composition is reported below in Table 3.

TABLE 3

| | Solid | Coating 1 | Coating 2 | Coating 3 | Coating 4 |
|---|---|---|---|---|---|
| Component | Weight % | (Weight %) | (Weight %) | (Weight %) | (Weight %) |
| Deionized | 0 | — | — | — | — |
| water | | | | | |
| Colloidal | 45 | 26.40 | 24.89 | 24.89 | 24.89 |
| Silica | | | | | |
| Thickener | 100 | 0.21 | 0.20 | 0.20 | 0.20 |
| Maleic acid | 0 | — | — | — | — |
| Isopropanol | 0 | — | — | — | — |
| MTMS | 56 | 33.93 | 31.99 | 31.99 | 31.99 |
| Alumina | 100 | 14.48 | 12.14 | 12.14 | 12.14 |
| powder | | | | | |
| Isopropanol | 0 | — | — | — | — |
| Titanium | 100 | 21.73 | 18.21 | 18.21 | 18.21 |
| pigment | | | | | |
| Matting agent | 100 | 2.72 | 2.28 | 2.28 | 2.28 |
| Wetting agent | 25 | 0.31 | 0.26 | 0.26 | 0.26 |
| Wetting agent | 25 | 0.21 | 0.18 | 0.18 | 0.18 |
| Mica | 100 | — | 9.84 | — | — |
| Wollastonite | 100 | — | — | 9.84 | — |
| Silicon | 100 | — | — | — | 9.84 |
| Carbide | | | | | |
| Total | | 100.00 | 100.00 | 100.00 | 100.00 |

### Example 2: Polyamide-Imide/Polyethersulfone Basecoat

Three formulations of organic polymer basecoats were prepared according to Table 4, below. The binder was progressively enriched with ceramic particle reinforcing particles of various size and composition; in particular, silicon carbide with particle size ranging from 5.6 to 55 um D50.

TABLE 4

| | | Coating 5 | Coating 6 | Coating 7 |
|---|---|---|---|---|
| | | (Weight | (Weight | (Weight |
| Component | Function | %) | %) | %) |
| PAI polymer | PAI polymer | 24.82 | 22.46 | 22.46 |
| PES powder | PES polymer | 6.21 | 5.62 | 5.62 |
| Ammonium | surfactant for | 1.22 | 1.11 | 1.11 |
| benzoate | polymer premix | | | |
| Alumina powder | additive for | 6.10 | 5.53 | 5.53 |
| | polymer blend | | | |
| Blue pigment | blue pigment | 2.44 | 2.21 | 2.21 |
| Thickener | fumed silica | 0.55 | 0.50 | 0.50 |
| | thickener | | | |
| Acetylenic surfactant | surfactant | 0.22 | 0.20 | 0.20 |
| Alkyl ethoxylate | surfactant | 2.21 | 2.00 | 2.00 |
| Surfactant | | | | |
| Deionized water | water | 46.50 | 42.08 | 42.08 |
| Water-borne black | black pigment | 2.21 | 2.00 | 2.00 |
| paste | | | | |
| Hydroxy ethyl | hydroxy ethyl | 0.90 | 0.82 | 0.82 |
| cellulose thickener | cellulose thickener | | | |
| Butyl oxitol/ | thinner for | 0.15 | 0.14 | 0.14 |
| Cellosolve | polymer blend | | | |
| Deionized water | water | 6.46 | 5.85 | 5.85 |
| Silicon carbide 800 | reinforcing | — | 9.50 | 3.00 |
| mesh | particles | | | |
| Silicon carbide 600 | reinforcing | — | — | 3.00 |
| mesh | particles | | | |
| Silicon carbide 240 | reinforcing | — | — | 3.00 |
| mesh | particles | | | |
| Silicon carbide 220 | reinforcing | — | — | 0.50 |
| mesh | particles | | | |

The formulations were prepared as follows: the polymers were added to ammonium benzoate, and the mixture was transferred to a ball mill. The mixture was ground, gradually adding water and additives, such as reinforcing particles, thickeners, pigments, and surfactants. The mixture was ground for 48 hours. Black pigment was then added and stirred until the mixture was homogeneously colored. A hydroxyethyl cellulose thickener was stirred into water and added to the mixture, along with any desired thinners. Finally, silicon carbide mesh was added and dispersed throughout the mixture via high-speed mixing.

The basecoats were then applied to an aluminum substrate, flashed at 100-150° C. for 5-10 minutes, then overcoated with a siloxane overcoat formulation such as those reported in the Examples below. The coated parts were then cured at 300° C. for 20 minutes. The dry coating composition is reported below in Table 5.

TABLE 5

| | Solid | Coating 5 | Coating 6 | Coating 7 | Coating 8 |
|---|---|---|---|---|---|
| | Weight | (Weight | (Weight | (Weight | (Weight |
| Component | % | %) | %) | %) | %) |
| PAI polymer | 33 | 25.81 | 19.40 | 19.40 | 19.40 |
| PES powder | 100 | 19.56 | 14.69 | 14.69 | 14.69 |
| Ammonium | 100 | 3.85 | 2.89 | 2.89 | 2.89 |
| benzoate | | | | | |
| Alumina powder | 100 | 19.24 | 14.46 | 14.46 | 14.46 |
| Blue pigment | 100 | 7.70 | 5.78 | 5.78 | 5.78 |
| Thickener | 100 | 1.74 | 1.31 | 1.31 | 1.31 |
| Acetylenic | 25 | 1.74 | 1.31 | 1.31 | 1.31 |
| surfactant | | | | | |
| Alkyl ethoxylate | 100 | 20.36 | 15.30 | 15.30 | 15.30 |
| Surfactant | | | | | |
| Deionized water | 100 | — | — | 24.86 | 7.85 |
| Water-borne black | 100 | — | — | — | 7.85 |
| paste | | | | | |
| Hydroxy ethyl | 100 | — | — | — | 7.85 |
| cellulose thickener | | | | | |
| Butyl | 100 | — | — | — | 1.31 |
| oxitol/Cellosolve | | | | | |

### Example 3: Polyphenylene Sulfide Basecoat

A formulation of an organic polymer basecoat was prepared according to Table 6, below, using polyphenylene sulfide as the organic polymer. The composition is suitable for use with the overcoats described below to form the multicoat compositions of the present disclosure.

TABLE 6

| | | Wet | Dry Film |
|---|---|---|---|
| | | Composition | Weight |
| Component | Function | Weight % | % |
| 2-Amino-2-methyl-2- | solvent | 1.1 | — |
| propanol 95% | | | |
| Deionized water | water | 33.2 | — |
| Colloidal silica | nanofiller | 2.1 | 1.4 |
| PPS polymer binder | binder | 29.3 | 65.6 |
| Grinding aid additive | grinding aid additive | 0.1 | 0.1 |
| Wetting agent | wetting agent | 3.6 | — |
| Thickener | thickener | 0.5 | 1.1 |
| Monopropylene glycol | solvent | 15.9 | — |
| Black pigment | black pigment | 1.3 | 2.8 |
| Defoaming additive | defoaming additive | 0.1 | — |
| Barium sulfate extender | extender | 12.6 | 28.1 |
| Ammonium benzoate | pH regulator | 0.3 | 0.8 |
| Total | | 100.00 | 100.00 |

### Example 4: Polyether Ether Ketone Basecoat

A formulation of an organic polymer basecoat was prepared according to Table 7, below, using polyether ether ketone as the organic polymer. The composition was prepared with silicon carbide reinforcing particles. The composition is suitable for use with the overcoats described below to form the multicoat compositions of the present disclosure.

TABLE 7

| | | Wet | Dry Film |
|---|---|---|---|
| | | Composition | Weight |
| Component | Function | Weight % | % |
| Silicon carbide | reinforcing particles | 4.25 | 14.80 |
| Defoaming additive | defoaming additive | 0.95 | 1.66 |
| Surfactant | surfactant | 4.88 | — |
| Alkali-soluble associative | thickener | 0.36 | 0.35 |
| Thickener | | | |
| Monopropylene glycol | solvent | 20.13 | — |
| PEEK resin | main binder | 21.35 | 74.39 |
| Deionized water | | 45.49 | — |
| Black pigment | black pigment | 2.52 | 8.80 |
| 2-Amino-2-methyl-2- | pH regulator, solvent | 0.05 | — |
| propanol 95% | | | |
| Defoaming additive | defoaming additive | 0.01 | 0.00 |
| Total | | 100.00 | 100.00 |

### Example 5: Silicon Elastomer Basecoat

Two basecoat formulations comprising silicon elastomers were prepared according to Table 8, below. In one run, silicon carbide particles of 30 and 70 microns were added to the composition via high speed mixing.

TABLE 8

| | | Coating 9 | Coating 10 |
|---|---|---|---|
| Component | Description | (Weight %) | (Weight %) |
| Vinylsiloxane | Vinyl Q-resin dispersion, 30% of resin in | 62.59 | 59.60 |
| | 10000 cSt vinyl-terminated PDMS | | |
| Hydrosiloxane | Polymethylhydrosiloxane, trimethylsilyl | 12.52 | 11.92 |
| | terminated, 20-35 cSt | | |
| Vinylsiloxane | Vinylmethylsiloxane homopolymer, | 8.02 | 7.64 |
| | cyclics, 3-7 cst | | |
| Poly- | Polydimethylsiloxane, trimethylsilyl | 5.01 | 4.77 |
| dimethyl- | terminated, 350 cSt | | |
| silxoane | | | |
| Catalyst | Platinum-cyclovinylmethyl- siloxane | 7.69 | 7.32 |
| | complex; 0.02% Pt in xylene | | |
| Pigment | Black pigment | 4.18 | 3.98 |
| Reinforcing | Silicon Carbide 600 grit | | 2.39 |
| particles | | | |
| Reinforcing | Silicon Carbide 240 grit | — | 2.39 |
| particles | | | |
| Total | | 100.00 | 100.00 |

The composition is quickly applied to a metal substrate and overcoated with a siloxane composition such as those described below. The substrate is dried at 100-150° C. for 5-10 minutes, and subsequently cured at 300° C. for 20 minutes. The composition of the dry coating is expected to be substantially unchanged from the composition provided in Table 6 as the composition does not include volatile components.

### Example 6: Binders

Five different binders were formulated in various basecoat compositions. The binders were selected in a scale of hardness and modulus. The different binders are described below in Table 9.

TABLE 9

| Coating | Binder | | Degree of |
|---|---|---|---|
| ID | chemistry | Chemical description of the binder | crosslinking |
| Coating 4 | Sol-gel | Gelation of methyltrimethoxysilane | 85% |
| | | (MTMS) and colloidal silica | |
| Coating 11 | Silicone resin | Methyl-phenyl silicone resin | 75% |
| | | with 1.0 P/M ratio | |
| Coating 12 | Silicone resin | Methyl-phenyl silicone resin | 63% |
| | | with 0.7 P/M ratio | |
| Coating 13 | Polyether sulfone | Polyether sulfone resin with reactive | N/A |
| | | hydroxyl reactive end-cappings | |
| Coating 64 | Silicone | The elastomer is prepared by | 55% |
| | elastomer | dehydrogenative coupling reaction of | |
| | | silanols and silicone hydrides, with a | |
| | | methyl-silicone resin co-binder | |

The different binders were compared to each other in formulations with the same reinforcing particles type and filling factor. The compositions of the different basecoat formulations are shown below in Table 10.

TABLE 10

| | Coating | Coating | Coating | Coating | Coating |
|---|---|---|---|---|---|
| | 4 | 11 | 12 | 13 | 14 |
| | (Weight | (Weight | (Weight | (Weight | (Weight |
| Description | %) | %) | %) | %) | %) |
| Thickener | 0.09 | — | — | — | — |
| Wetting agent | 0.47 | — | — | — | — |
| Deionized water | 6.13 | — | — | 52.20 | — |
| MTMS | 25.80 | — | — | — | — |
| Isopropanol | 22.78 | — | — | — | — |
| Colloidal silica | 24.98 | — | — | — | — |
| Maleic acid | 0.24 | — | — | — | — |
| Wetting agent | 0.33 | — | — | — | — |
| Methyl-phenyl | — | 25.69 | — | — | — |
| silicone resin | | | | | |
| Methyl-phenyl | — | — | 51.38 | — | — |
| silicone resin | | | | | |
| (sol. 50% Xylene) | | | | | |
| Xylene | | 53.13 | 27.44 | — | — |
| PES resin | — | — | — | 17.40 | — |
| N-Ethyl-2- | — | — | — | 17.40 | — |
| pyrrolidone | | | | | |
| OH-terminated | — | — | — | — | 10.72 |
| PDMS 10cSt | | | | | |
| OH-terminated | — | — | — | — | 10.58 |
| PDMS with | | | | | |
| rheology additive | | | | | |
| OH-terminated | — | — | — | — | 14.29 |
| PDMS 33% | | | | | |
| silicon resin | | | | | |
| HMe-DMS | — | — | — | — | 21.44 |
| copolymer | | | | | |
| Platinum-cyclo- | — | — | — | — | 0.08 |
| vinylmethyl- | | | | | |
| siloxane complex; | | | | | |
| 0.02% in | | | | | |
| xylene | | | | | |
| Tin(II) solution | — | 2.00 | 2.00 | — | 0.14 |
| 2% xylene | | | | | |
| White pigment | 8.22 | 8.22 | 8.22 | 5.57 | 18.32 |
| Silicon carbide | 4.45 | 4.45 | 4.45 | 3.01 | 9.92 |
| Alumina powder | 5.48 | 5.48 | 5.48 | 3.71 | 12.22 |
| Matting agent | 1.03 | 1.03 | 1.03 | 0.70 | 2.30 |
| Total | 100.00 | 100.00 | 100.00 | 100.00 | 100.00 |

The formulations were designed such that the type and amount of reinforcing particles were identical for each composition when normalized on the dry weight of the polymer, as shown in below in Table 11. The dry coating compositions were determined following application of the basecoats to grit-blasted aluminum substrate, flashed off at 100-150° C. for 5-10 minutes, then overcoated with a siloxane overcoat formulation such as those reported in the Examples below. The coated parts were cured at 300° C. for 20 minutes. The dry coating compositions are shown in Table 11.

TABLE 11

| | Coating | Coating | Coating | Coating | Coating |
|---|---|---|---|---|---|
| Component | 4 | 11 | 12 | 13 | 14 |
| Thickener | 0.20 | — | — | — | — |
| Wetting agent | 0.26 | — | — | — | — |
| MTMS | 31.99 | — | — | — | — |
| Colloidal silica | 24.89 | — | — | — | — |
| Wetting agent | 0.18 | — | — | — | — |
| Methyl-phenyl silicone resin | — | 57.20 | — | — | — |
| Methyl-phenyl silicone resin | — | — | 57.20 | — | — |
| (solution, 50% Xylene) | | | | | |
| Xylene | — | — | — | — | — |
| PES polymer | — | — | — | 57.25 | — |
| OH-terminated PDMS 10 cSt | — | — | — | — | 10.74 |
| OH-terminated PDMS 10% | — | — | — | — | 10.60 |
| rheology modifier | | | | | |
| OH-terminated PDMS 33% silicone | — | — | — | — | 14.32 |
| resin | | | | | |
| HMe-DMS copolymer | — | — | — | — | 21.48 |
| Platinum-cyclovinylmethyl-siloxane | — | — | — | — | 0.00 |
| complex; 0.02% in xylene | | | | | |
| Tin(II) solution, 2% xylene | — | 0.09 | 0.09 | — | 0.00 |
| White pigment | 18.21 | 18.31 | 18.31 | 18.32 | 18.36 |
| Silicon carbide | 9.85 | 9.91 | 9.91 | 9.92 | 9.94 |
| Alumina powder | 12.14 | 12.20 | 12.20 | 12.22 | 12.24 |
| Matting agent | 2.28 | 2.30 | 2.30 | 2.30 | 2.30 |
| Total | 100.00 | 100.00 | 100.00 | 100.00 | 100.00 |

### Example 7: Hydrosilylation Overcoat

A representative composition suitable for overcoats formed through the hydrosilylation reaction between hydrosiloxane and vinylsiloxane moieties is shown below in Table 12. The composition is mixed in a container until it becomes homogeneous, after which it is quickly applied by airmix spraying directly on to a metallic substrate or a basecoat of a different chemical composition. After application, the composition is dried at 100-150° C. for 5 to 10 minutes and cured at 300° C. for 20 minutes.

TABLE 12

| | | Viscosity | Weight |
|---|---|---|---|
| Component Description | Ingredient Function | (cSt) | % |
| Vinyl Q-resin dispersion, 30% of | Vinyl-functionalized | 4500-7000 | 65.32 |
| resin in 10000 cSt vinyl-terminated | siloxane hardened with | | |
| polydimethylsiloxane | MQ resin | | |
| Polymethylhydrosiloxane, | Siloxane crosslinker | 20-35 | 13.06 |
| trimethylsilyl-terminated, 20-35 cSt | | | |
| Vinylmethylsiloxane homopolymer, | Vinyl-functionalized | 3-7 | 8.37 |
| cyclics, 3-7 cst | siloxane, cyclic | | |
| Polydimethylsiloxane, trimethylsilyl- | Unreactive PDMS, | 350 | 5.23 |
| terminated, 350 cSt | nonstick aid | | |
| Platinum-cyclovinylmethyl-siloxane | Catalyst for | | 8.02 |
| complex; 0.02% in xylene | hydrosilylation | | |
| Total | | | 100.00 |

The dry coating composition is expected to be substantially unchanged from the wet coating composition reported in Error! Reference source not found.2, as all components are non-volatile. The degree of crosslinking in the coating is between 505 and 60%.

The film obtained by the composition of Table 12 is characterized by high hydrophobicity and good non-stick properties for release of food stuff, and low hardness.

### Example 8: Dehydrogenative Coupling Overcoat

A representative composition suitable for overcoats formed through the dehydrogenative coupling reaction between hydrosiloxane and hydroxysiloxane moieties is shown below in Table 13 The composition is mixed in a container until it becomes homogeneous, after which it is quickly applied by airmix spraying directly on to a metallic substrate or a basecoat of a different chemical composition. After application, the composition is dried at 100-150° C. for 5 to 10 minutes and cured at 300° C. for 20 minutes.

TABLE 13

| | | Viscosity | Weight |
|---|---|---|---|
| Component Description | Function | (cSt) | % |
| Silanol-trimethylsilyl modified | Hydroxide carrying MQ | 3000-4000 | 25.58 |
| Q resin | resin, film hardener | | |
| Hydroxyl-terminated | Reactive siloxane, hydroxyl | 5000 | 59.68 |
| polydimethylsiloxane | terminated | | |
| Trimethylsilyl-terminated | Siloxane crosslinker | 20-35 | 3.41 |
| polymethylhydrosiloxane | | | |
| Trimethylsilyl-terminated | Unreactive PDMS, nonstick | 350 | 5.54 |
| polydimethylsiloxane, | aid | | |
| Tin(II)2-ethylhexanoate (2% | Catalyst | | 2.90 |
| solution in xylene) | | | |
| Platinum-cyclovinylmethyl- | Catalyst | | 2.90 |
| siloxane complex (0.02% Pt in | | | |
| xylene) | | | |
| Total | | | 100.00 |

The dry coating composition is expected to be substantially unchanged from the wet coating composition reported in Table 13, as all components are non-volatile. The degree of crosslinking in the coating is between 50% and 60%.

The film obtained by the composition of Table 13 is characterized by high hydrophobicity and good non-stick properties for release of food stuff, and low hardness.

### Example 9: Polycondensation Overcoat

A representative composition suitable for overcoats formed through the polycondensation reaction between hydroxysiloxane or alkoxysiloxane moieties is shown below in Table 14. The composition is mixed in a container until it becomes homogeneous, after which it is quickly applied by airmix spraying directly on to a metallic substrate or a basecoat of a different chemical composition. After application, the composition is dried at 100-150° C. for 5 to 10 minutes and cured at 300° C. for 20 minutes.

TABLE 14

| Description | Function | Weight % |
|---|---|---|
| Condensation-curing methyl silicone resin | Hydroxy-functional methyl | 10.0 |
| | silicone resin | |
| Methoxy-functional methyl polysiloxane; | Hydroxyl-functional siloxane | 23.3 |
| methyl ester of a mixture of different | crosslinker | |
| oligomeric methylsilicates | | |
| Reactive polydimethylsiloxane, 2,000 cSt | Hydroxyl-terminated linear | 33.3 |
| | siloxane | |
| Trimethylsilyl-terminated | Unreactive PDMS, nonstick | 6.7 |
| polydimethylsiloxane, 350 cSt | aid | |
| Xylene | Solvent | 26.6 |
| Tin(II)Ethyl Hexanoate | Catalyst | 0.05 |
| Total | | 100.0 |

### Example 10: Abrasion and Scratch Resistance of Silicon Elastomer Basecoats

The above-described coatings were tested for abrasion resistance using the Reciprocating Abrasion Test (RAT). The movement performed by the RAT machine simulates abrasion during cleaning with a domestic scouring pad. The RAT machine generally has variable settings for speed and applied load. The rating is the number of cycles the coating survives until 10% of the substrate is exposed; 1 cycle=2 strokes.

The coatings were further tested for scratch resistance using the Scratch Adhesion “Happy Flower” Test (HFT). The test is performed using a pen tip affixed to a balance arm calibrated with a specific weight, where the article is put on a revolving heated turntable (150° C., oil filled). After two hours, the test is stopped, and a score is assigned according to the degree of surface damage. The results are classified as 10: no effect; 9: no wear; 8: minimal wear; 7: some wear; 6: light damage; 5: moderate damage; 4: considerable damage; 3: severe damage; 2: extensive damage; 1: widespread failure; 0: total failure.

The formulations shown below in Table 15 were tested for scratch and abrasion resistance. Basecoat 9 is a silicon basecoat with no reinforcing particles, as described in an Example above, while Basecoat 10 includes silicon carbide reinforcing particles, as described in an Example above.

TABLE 15

| | | | RAT | Scratch | Scratch |
|---|---|---|---|---|---|
| Run | | | (cycles/ | adhesion | abrasion |
| # | Basecoat | Overcoat | micron) | score | survival (%) |
| 1 | 9 | Hydrosilylation | 0.7 | 0 | 0 |
| 2 | 10 | Hydrosilylation | 9 | 0 | 0 |

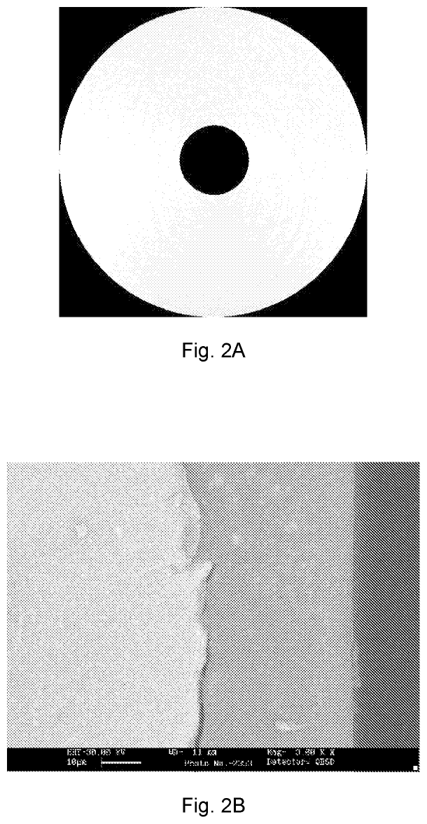

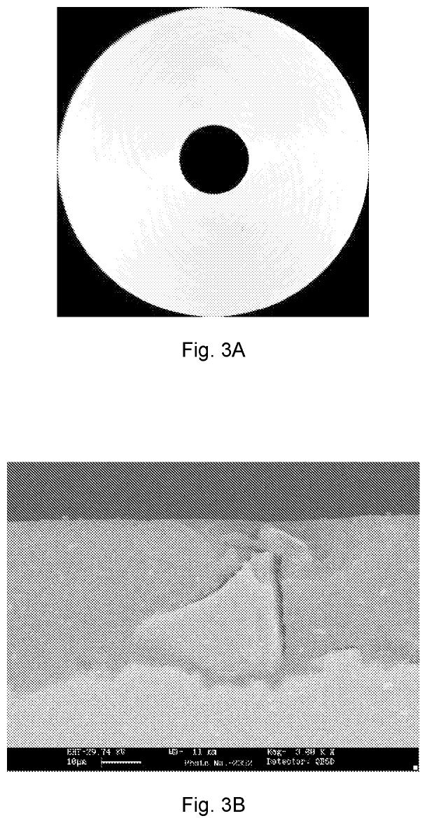

FIG. 2A shows a scratch adhesion picture of the coating of Run 1 following testing, and FIG. 2B shows a picture of the same coating in cross section following testing. FIG. 3A shows a scratch adhesion picture of the coating of Run 2 following testing, and FIG. 2B shows a picture of the same coating in cross section following testing. These tests show the extreme mechanical weakness of a system based solely on silicone elastomer chemistry. The coating is easily ripped from the substrate and can be polished by an abrasive pad with little to no effort. The cross section in FIG. 3B shows the presence of large reinforcing particles crossing the coating, but the weak nature of the basecoat makes it mostly ineffective in providing mechanical toughening, and the gain in abrasion cycles is only marginal.

### Example 11: Abrasion and Scratch Resistance of Sol-Gel Basecoats

The formulations shown below in Table 16 were tested for abrasion and scratch resistance using the tests described in the Example above. The formulations used sol-gel basecoats both without reinforcing particles and with different reinforcing particles, as described in the above Examples. In each case, the overcoat was a siloxane film formed through dehydrogenative coupling as described in the above Examples.

TABLE 16

| | | | RAT | Scratch | Scratch |
|---|---|---|---|---|---|
| Run | | | (cycles/ | adhesion | abrasion |
| # | Basecoat | Overcoat | micron) | score | survival (%) |
| 3 | 1 | Dehydrogenative | 88 | 3 | 73 |
| 4 | 2 | Dehydrogenative | 72 | 1 | 11 |
| 5 | 3 | Dehydrogenative | 234 | 1 | 9 |
| 6 | 4 | Dehydrogenative | 347 | 4 | 84 |

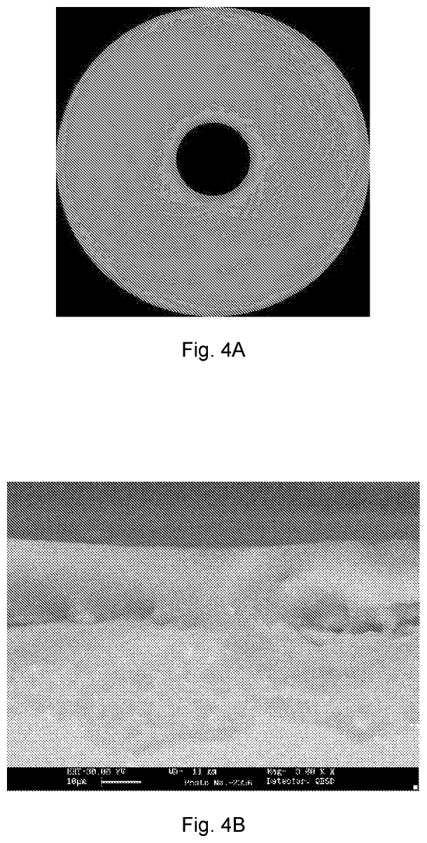

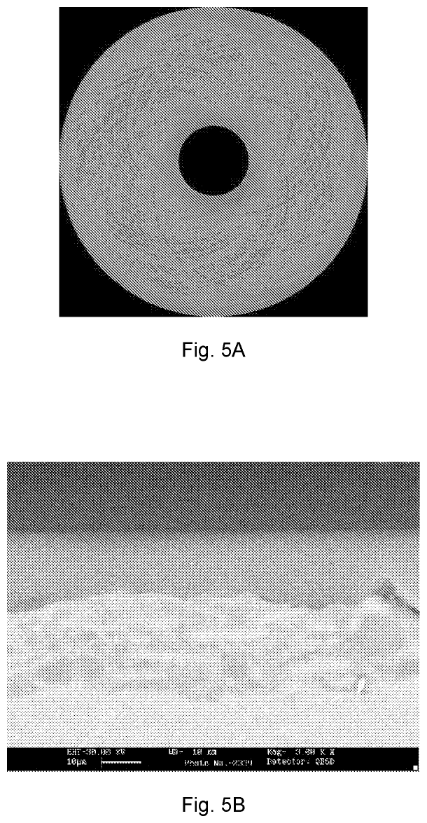

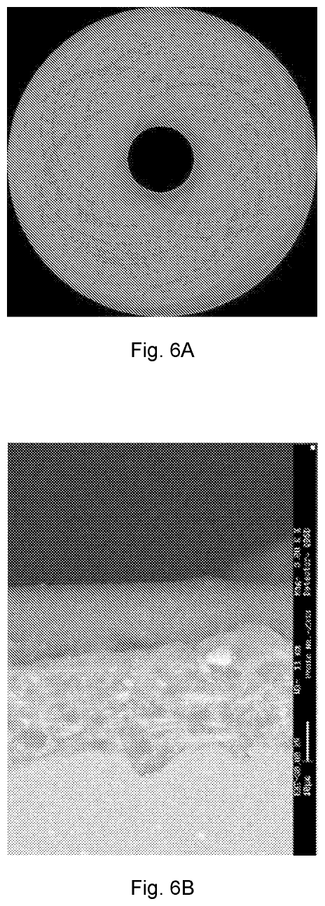

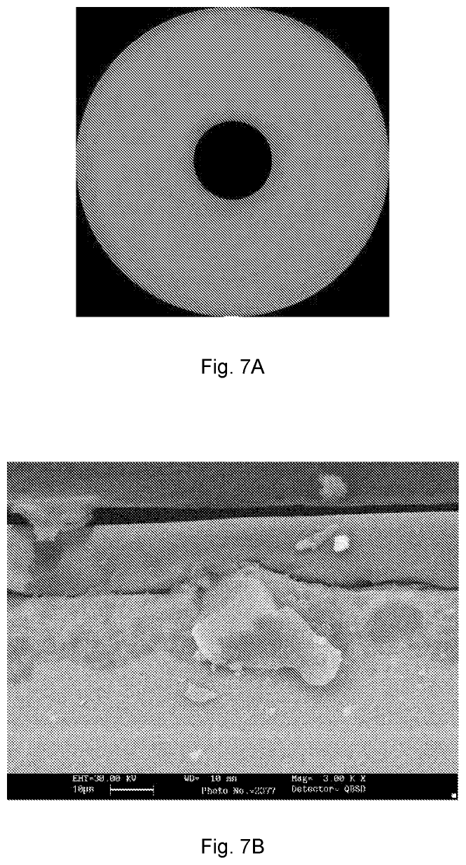

FIGS. 4A and 4B show the scratch adhesion picture and cross section, respectively, of the coating of Run 3. FIGS. 5A and 5B show the scratch adhesion picture and cross section, respectively, of the coating of Run 4. FIGS. 6A and 6B show the scratch adhesion picture and cross section, respectively, of the coating of Run 5. FIGS. 7A and 7B show the scratch adhesion picture and cross section, respectively, of the coating of Run 6.

As can be seen in both Table 16 and the Figures mentioned above, these coatings show significant improvement imparted to the mechanical resistance of the system when a sol-gel basecoat is used. In particular, abrasion resistance improved by 2 and 3 orders of magnitude compared to the above Example using the silicon elastomer basecoat.

The scratch resistance of the coating is also improved in comparison to the silicon elastomer basecoat. Specifically, the survival of the coating on up to 84% of the tested surface was observed.

Noticeably, in terms of RAT data, Runs 5 and 6 displayed abrasion resistance far superior to coatings of Runs 3 and 4. The increased performance may be attributed to the increased hardness of the reinforcing particles in Runs 5 and 6 that in turn contribute to the hardness of the coating system. The coating of Run 3 does not include reinforcing particles. The muscovite reinforcing particles of Run 4 has a Mohs hardness of about 2.5, while the wollastonite reinforcing particles of Run 5 has a Mohs hardness of 6 and the silicon carbide reinforcing particles of Run 6 has a Mohs hardness of 9. Therefore, it appears that reinforcing particles with Mohs hardness of greater than 4 may significantly increase the abrasion resistance of the coating system.

### Example 12: Abrasion and Scratch Resistance of Polyether Sulfone/Polyamide-Imide Basecoats

The formulations shown below in Table 17 were tested for abrasion and scratch resistance using the tests described in the Example above. The formulations used organic polymer basecoats as described in the above Examples. The overcoat was either a siloxane film formed through dehydrogenative coupling or hydrosilylation, as noted in Table 17.

TABLE 17

| | | | RAT | Scratch | Scratch |
|---|---|---|---|---|---|
| Run | | | (cycles/ | adhesion | abrasion |
| # | Basecoat | Overcoat | micron) | score | survival (%) |
| 7 | 5 | Dehydrogenative | 9.5 | 7 | 98.9 |
| 8 | 6 | Hydrosilylation | 136 | 7 | 96.3 |
| 9 | 7 | Hydrosilylation | 142 | 9 | 100 |

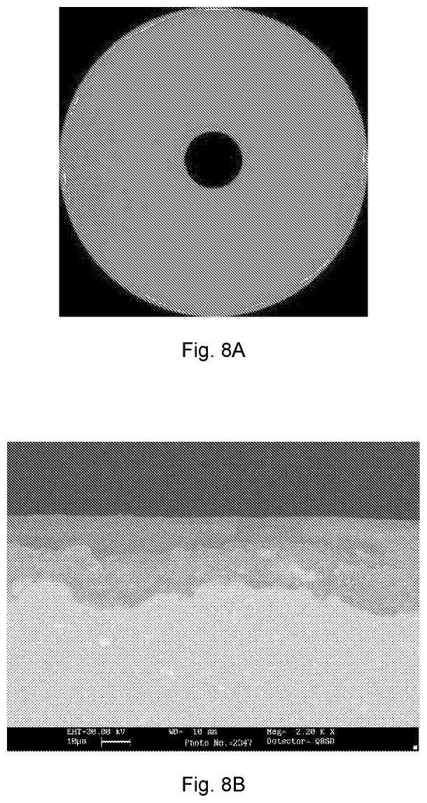

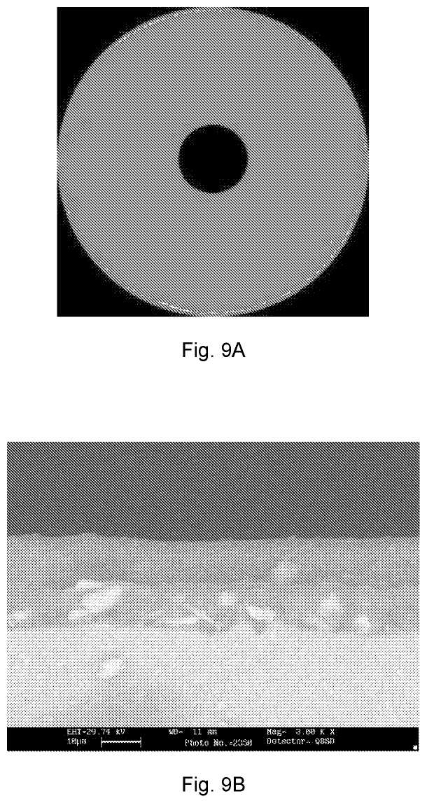

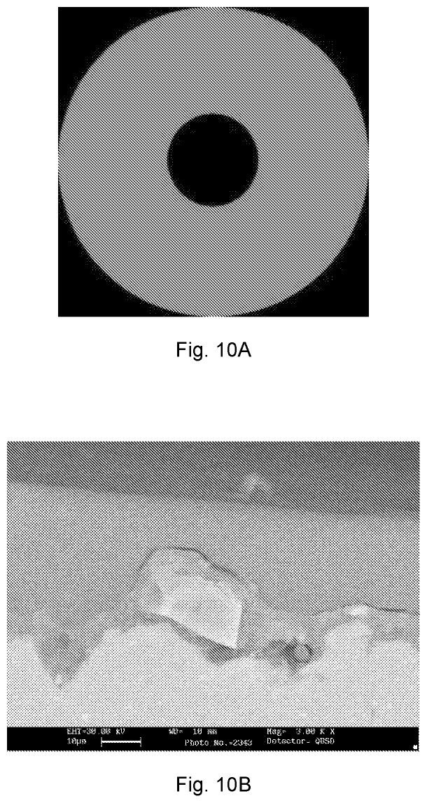

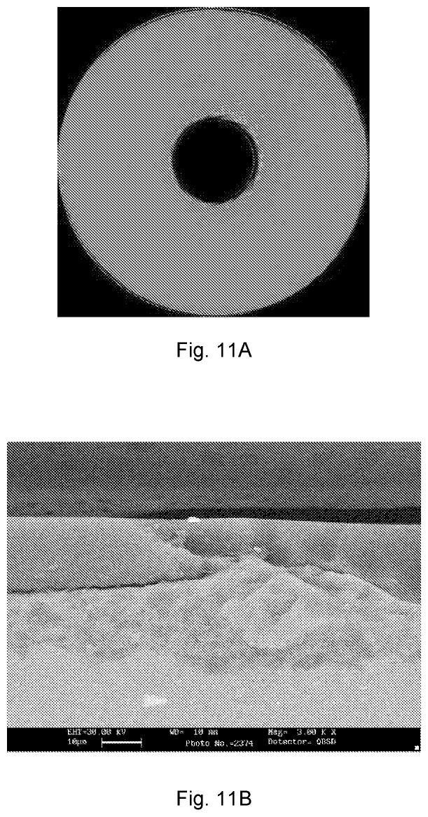

FIGS. 8A and 8B show the scratch adhesion picture and cross section, respectively, of the coating of Run 7. FIGS. 9A and 9B show the scratch adhesion picture and cross section, respectively, of the coating of Run 8. FIGS. 10A and 10B show the scratch adhesion picture and cross section, respectively, of the coating of Run 9.

This set of experiments shows the synergistic effect of reinforcing particles and a tougher primer based on a PAI/PES polymeric composition. While the composition of Run 7 shows increased scratch resistance of the system, the absence of hard reinforcing particles from the composition allows only a marginal benefit to the overall abrasion resistance. Runs 8 and 9, in which the basecoats include silicon carbide reinforcing particles (Mohs hardness 9) cooperate with the tough basecoat composition to create a structure capable of reinforcing the overall system and making it abrasion and scratch resistant.

Surprisingly, the particle size does not appear to affect abrasion resistance significantly; relatively small reinforcing particles provide the same improvement as larger particles. However, there is an apparent synergistic effect between reinforcing particle hardness and polymer hardness, resulting in a change the abrasion resistance cycles per micron from 9 to 140 as silicon carbide is introduced in the system.

### Example 13: Comparison of Abrasion and Scratch Resistance of Various Basecoats

The formulations shown below in Table 18 were tested for abrasion and scratch resistance using the tests described in the Example above. In each case, the overcoat was a siloxane film formed through hydrosilylation. The same type and amount of reinforcing particles were used in each Run. Each run differed in its basecoat composition; the formulations used the silicon resins, polyether sulfone, or silicon elastomers described in the above Examples.

TABLE 18

| | | | RAT | Scratch | Scratch |
|---|---|---|---|---|---|
| Run | | | (cycles/ | adhesion | abrasion |
| # | Basecoat | Overcoat | micron) | score | survival (%) |
| 10 | 4 | Hydrosilylation | 397 | 4 | 91.7 |
| 11 | 11 | Hydrosilylation | 192 | 3 | 87.6 |
| 12 | 12 | Hydrosilylation | 23 | N/A | N/A |
| 13 | 13 | Hydrosilylation | 142 | 8 | 99 |
| 14 | 14 | Hydrosilylation | 8.6 | 1 | 0 |

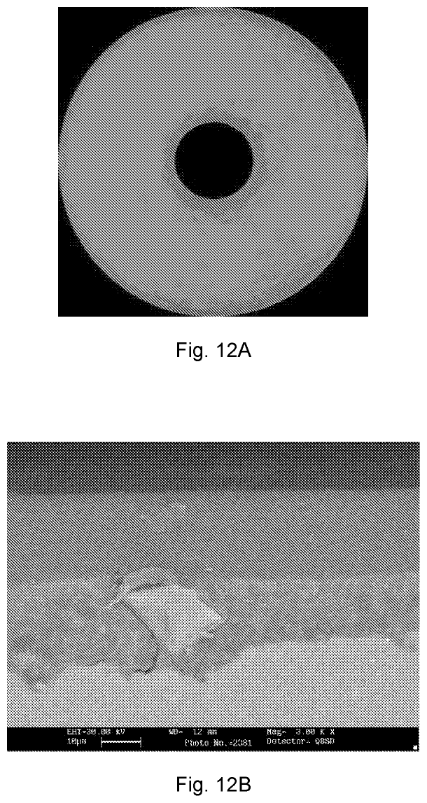

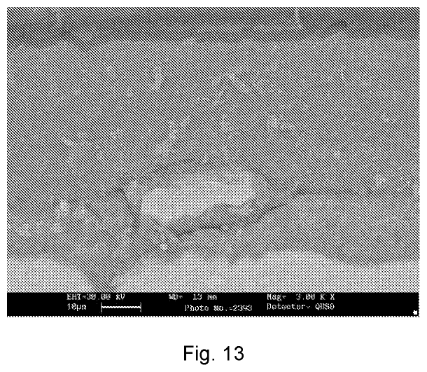

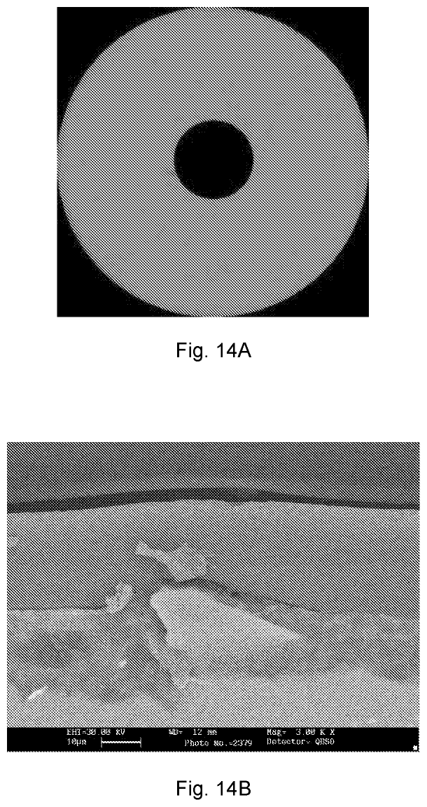

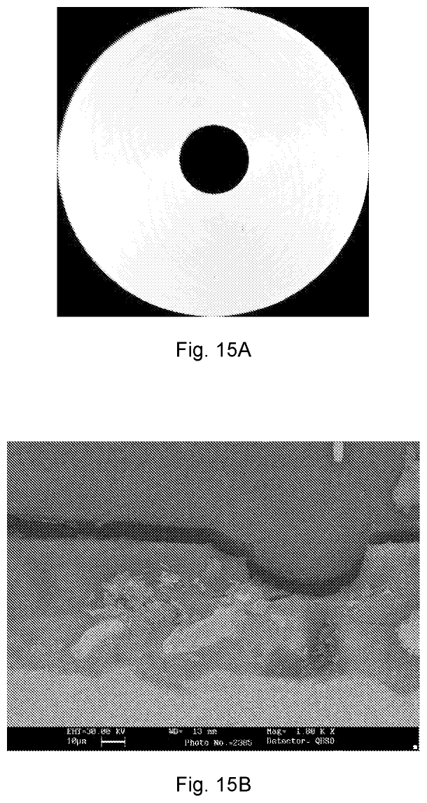

FIGS. 1A and 1B show the scratch adhesion picture and cross section, respectively, of the coating of Run 10. FIGS. 12A and 12B show the scratch adhesion picture and cross section, respectively, of the coating of Run 11. FIG. 13 shows the cross section of the coating of Run 12. FIGS. 14A and 14B show the scratch adhesion picture and cross section, respectively, of the coating of Run 13. FIGS. 15A and 15B show the scratch adhesion picture and cross section, respectively, of the coating of Run 14.

### Example 14: Nano-Indentation Hardness of Various Basecoats

The coating compositions of Runs 10-14 (described above) were tested for nano-indentation hardness using the parameters described in Table 19 below.

TABLE 19

| Instrument PB1000 | Units | Micro module |
|---|---|---|
| Approaching speed | um/min | 50 |
| Contact load | mN | 10 |
| Target load | N | 0.1 |
| Loading rate | N/min | 0.2 |
| Unloading rate | N/min | 0.2 |
| Indenter | — | Vickers |
| Material | — | Diamond |

The results of the tests are shown below in Table 20.

TABLE 20

| | | Elastic | Total | Elastic | Plastic | | HFT | Abrasion |
|---|---|---|---|---|---|---|---|---|
| | Martens | Modulus | Energy | Energy | Energy | HFT | Surviving | Resistance |
| Run | (GPa) | (GPa) | (nJ) | (nJ) | (nJ) | score | Area (%) | (cycles/um) |
| 10 | 0.619 | 11.343 | 97.82 | 48.42 | 49.401 | 4 | 91.7 | 397.7273 |
| 11 | 0.171667 | 5.326 | 171.8 | 50.26 | 121.51 | 3 | 87.6 | 192.3077 |
| 12 | 0.122 | 8.802 | 217.9 | 22.73 | 195.17 | — | — | 23.4375 |
| 13 | 0.531 | 16.785 | 119.5 | 26.42 | 93.06 | 8 | 99 | 287.5 |
| 14 | 0.08825 | 1.999 | 215 | 100.5 | 114.43 | 1 | 0 | 8.653846 |

### Example 15: Overcoats Prepared Via Hydrosilylation Reactions

In this Example, overcoats were prepared from the components listed in Table 21 below to demonstrate the synergistic effects of a co-binder such as a VQ resin and an inorganic filler with an aspect ratio to the mechanical properties of silicone elastomer overcoats prepared by a hydrosilylation reaction between a linear vinyl-terminated polydimethylsiloxane and a polydimethylsiloxane including hydride groups, as catalyzed by Ashby's catalyst.

The compositions were prepared by blending the components through high speed dispersion until homogeneous, and subsequently spraying the resulting compositions within the same day of the preparation on a metal substrate made of aluminum 3003 alloy. The compositions were then subjected to cure for 20 minutes at 300° C. in a box oven. The compositions and test results are shown below in Tables 21A and 21B.

TABLE 21A

| | | | | Comp. | Comp. | Comp. | | |
|---|---|---|---|---|---|---|---|---|
| | | Comp. 1 | Comp. 2 | 3 | 4 | 5 | Inv. 1 | Inv. 2 |
| | | Weight | Weight | Weight | Weight | Weight | Weight | Weight |
| Ingredient code | Ingredient description | % | % | % | % | % | % | % |
| Silmer VIN | PDMS with vinyl | 94.54 | | | | | | |
| 1000 | endcaps 1000 cSt | | | | | | | |
| Silmer | PDMS with vinyl | | 96.73 | 39.87 | | | | |
| VIN5000 | endcaps 5000 cSt | | | | | | | |
| Silmer | PDMS with vinyl | | | | 97.76 | 92.24 | 47.92 | 46.41 |
| VIN10000 | endcaps 10000 cSt | | | | | | | |
| Gelest HMS- | Hydride functional | 4.32 | 2.13 | 19.14 | 1.20 | 1.12 | 30.54 | 29.58 |
| 301 | dimethyl siloxane | | | | | | | |
| 2% Ashby's | Ashby's catalyst Pt soln | 1.14 | 1.13 | 1.13 | 1.04 | 1.04 | 1.00 | 1.00 |
| catalyst in | 2% in Xylene | | | | | | | |
| xylene | | | | | | | | |
| Gelest VDT- | PDMS with 7% methyl | | | 39.87 | | | | |
| 731 | vinyl siloxane along the | | | | | | | |
| | chain | | | | | | | |
| Silmer VQ20 | Vinyl functional | | | | | | 20.54 | 19.90 |
| | siloxane Q-resin | | | | | | | |
| BRB MQ339 | Vinyl functional | | | | | | | |
| | siloxane Q-resin | | | | | | | |
| Nyco Nyglos | Wollastonite filler | | | | | 5.60 | | 3.11 |
| 4W | | | | | | | | |
| Nyco 8 | Wollastonite filler | | | | | | | |
| Nygloss M | Wollastonite filler | | | | | | | |
| 9000 | | | | | | | | |
| Mica 5HG | Muscovite mica | | | | | | | |
| Carborex 800 | Silicon carbide | | | | | | | |
| | Force at critical load | 0.38925 | 0.300625 | 1.175 | 0.22 | 0.125 | 0.44 | 0.6375 |
| | LC2 (N) | | | | | | | |
| | Martens Hardness | 0.0016 | 0.0025 | 0.0146 | 0.0004 | 0.0079 | 0.0148 | 0.0299 |
| | (GPa) | | | | | | | |
| | Normalized max force | 0 | 0 | 1.86 | 0 | 0.04 | 0 | 0 |
| | to release whole egg | | | | | | | |
| | (N) | | | | | | | |
| | Specific work of | 0 | 0 | 3.87 | 0 | 0.1 | 0 | 0 |
| | adhesion for whole egg | | | | | | | |
| | (J/m2) | | | | | | | |

TABLE 21B

| | | | | | | Comp. | | | |
|---|---|---|---|---|---|---|---|---|---|
| Ingredient | | Inv. 3 | Inv. 4 | Inv. 5 | Inv. 6 | 6 | Inv. 8 | Inv. 9 | Inv.10 |
| code | Ingredient description | Wt. % | Wt. % | Wt. % | Wt. % | Wt. % | Wt. % | Wt. % | Wt. % |
| Silmer VIN | PDMS with vinyl | | | | | | | | |
| 1000 | endcaps 1000 cSt | | | | | | | | |
| Silmer | PDMS with vinyl | | | | | | | | |
| VIN5000 | endcaps 5000 cSt | | | | | | | | |
| Silmer | PDMS with vinyl | 45.19 | 46.00 | 46.00 | 46.00 | 46.00 | 57.24 | 46.00 | 52.25 |
| VIN10000 | endcaps 10000 cSt | | | | | | | | |
| Gelest HMS- | Hydride functional | 28.80 | 30.00 | 30.00 | 30.00 | 30.00 | 37.33 | 30.00 | 34.07 |
| 301 | dimethyl siloxane | | | | | | | | |
| 2% Ashby's | Ashby's catalyst Pt | 1.04 | 1.00 | 1.00 | 1.00 | 1.00 | 1.24 | 1.00 | 1.13 |
| catalyst in | soln 2% in Xylene | | | | | | | | |
| xylene | | | | | | | | | |
| Gelest VDT- | PDMS with 7% | | | | | | | | |
| 731 | methyl vinyl siloxane | | | | | | | | |
| | along the chain | | | | | | | | |
| Silmer VQ20 | Vinyl functional | 19.37 | 20.00 | 20.00 | 20.00 | 20.00 | 0.46 | | 9.13 |
| | siloxane Q-resin | | | | | | | | |
| BRB MQ339 | Vinyl functional | | | | | | | 20.00 | |
| | siloxane Q-resin | | | | | | | | |
| Nyco Nyglos | Wollastonite filler | 5.60 | | | | | 3.73 | 3.00 | 3.40 |
| 4W | | | | | | | | | |
| Nyco 8 | Wollastonite filler | | 3.00 | | | | | | |
| Nygloss M | Wollastonite filler | | | 3.00 | | | | | |
| 9000 | | | | | | | | | |
| Mica 5HG | Muscovite mica | | | | 3.00 | | | | |
| Carborex 800 | Silicon carbide | | | | | 3.00 | | | |
| | Force at critical load | 0.64 | 0.64 | 0.46 | 0.47 | 0.05 | 0.4 | 0.49 | 0.51 |
| | LC2 (N) | | | | | | | | |
| | MartensHardness | 0.026 | 0.0155 | 0.013 | 0.021 | 0.0104 | 0.016 | 0.019 | 0.014 |
| | (GPa) | | | | | | | | |
| | Normalized max | 0 | 0 | 0 | 0 | 0 | 0 | 0 | 0 |
| | force to release whole | | | | | | | | |
| | egg (N) | | | | | | | | |
| | Specific work of | 0 | 0 | 0 | 0 | 0 | 0 | 0 | 0 |

adhesion for whole
egg (J/m2)

The above results are also shown in FIG. 17.

The Martens hardness (GPa) was determined according to DIN ISO 14577 1-3 and using the parameters reported in Table 19 herein.

The normalized max force to release a whole egg (N) was determined using Nanovea PB1000 mechanical tester. Specifically, 0.4 g of a freshly whipped egg were cooked on the coated surface for 5 min at 120° C. and 10 min at 200° C. in a ventilated oven prior to the analysis. Afterwards, a stainless steel probe was moved through the food adhered on coated surfaces at 60 mm/s while applying a 5 N force for a length of 25 mm. During its passage, the whipped egg was removed, and the frictional force profile was recorded. The normalized max force to release corresponds to the maximum of the frictional force recorded.

The specific work of adhesion for whole egg (J/m²) was determined by mathematical treatment from the frictional force profile. Specifically, a frictional force baseline was first calculated in the range of 1-4 mm of the probe run, prior to the contact between the probe and the whipped egg. Subsequently, this value was then subtracted to each value of frictional force to obtain a normalized frictional force profile. The latter values were then used to calculate the work of adhesion by doing the average between two subsequent frictional force values and multiplying the result by the corresponding delta position. The sum of the values of work of adhesion was finally divided by the area of the Teflon containing the whipped egg to get the specific work of adhesion.

Comparative Examples 1, 2, and 4 show a progressive drop in mechanical properties as the vinyl chain is extended from 1000 to 10000 cSt. Similarly, Examples 1 and 2 show lack of film integrity and significant stress cracking of the film applied over aluminum substrate.

Comparative Example 3 shows a strong gain in mechanical properties provided by an additional crosslinker such as VDT 731, but at the expense of an equally large increase in the effort to remove food fouling.

Example 5 shows only marginal gain in mechanical properties obtained when wollastonite filler is introduced into the linear mix with 10000 cSt vinyl PDMS.

Example 1 shows the beneficial effect on hardness and scratch resistance of the introduction of a VQ resin in the system, without affecting the non-stick performance.

Examples 2 and 3 shows the synergistic effect of wollastonite, a filler with acicular aspect ratio, that increases the scratch resistance and indentation hardness of the resulting coatings.

Examples 4, 5 and 6 show that different inorganic fillers with aspect ratio, namely different grades of wollastonite and muscovite mica, provide a comparable enhancement in mechanical properties without affecting the non-stick properties. Comparative Example 6 shows that silicon carbide filler, despite having a greater specific hardness compared to wollastonite or muscovite, does not contribute positively to the increase in mechanical properties compared to the controls, likely due to the absence of an aspect ratio.

Example 8 shows that decreasing the amount of VQ resin to less than 0.5% in formula still largely preserves the mechanical properties of the blend, without compromising the non-stick.

Example 9 shows that a different grade of VQ resin, a BRB MQ339 polymer supplied by BRB silicones, performs nearly as good as VQ20 supplied by Gelest. Example 10 shows that increased hardness without a loss in non-stick are also obtained when the amount of VQ20 sets to 10%.

All the above-mentioned examples show an optical transparency with a transmittance of at least 50% at 550 nm wavelength when the coating is applied at 50 μm of dry film thickness.

### Example 16: Coatings Including Basecoats Together with Overcoats Prepared Via Hydrosilylation Reactions

A complete coating system is obtained by combining a basecoat of composition 13 of Table 8 with the overcoat Inv.3 of Table 21B. The basecoat is applied by spraying over a metal substrate such as aluminum alloy or stainless-steel alloy. The basecoat is flash dried at a temperature of 80-120° C. for 2-10 minutes, and subsequently the overcoat is applied by spraying on the dried basecoat. After application of the overcoat, the part is progressively heated to 300° C. and cured at that temperature for 20 minutes. The resulting multi-coat system displays superior mechanical properties and good non-stick and optical properties.

Wherein particular examples of this invention have been described above for purposes of illustration, it will be evident to those skilled in the art that numerous variations of the details of the present invention may be made without departing from the invention as defined in the appended claims. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

### Aspects

Aspect 1 is a coated article, comprising a substrate having a surface; and a coating disposed on the surface, comprising a basecoat having at least one of: a Martens hardness of 0.2 GPa or higher, as determined by nano-indentation according to DIN ISO 14577 1-3; and
an elastic modulus of 5 GPa or higher, as determined by DIN ISO 14577 1-3, the basecoat comprising at least one of (i) a sol-gel matrix formed from at least one siloxane of formula (I)

RₓSi(OR′)₄₋ₓ (I)
wherein R is one or more moieties chosen independently from linear, branched, or cyclic alkyl and aryl; R′ is methyl, ethyl, propyl or alkyl; and x is 0, 1, 2, or 3; (ii) an organic polymer having at least one of: a melt point of 200° C. or greater as determined by differential scanning calorimetry (DSC); a glass transition temperature of 90° C. or greater as determined by differential scanning calorimetry (DSC); and a heat deflection/distortion temperature of 100° C. or greater as determined by ASTM D648; and (iii) a silicone resin, the basecoat including at least one type of reinforcing particles having a Knoop hardness of at least 160 kg/m² as determined by ASTM C1326; and an overcoat disposed on the basecoat and comprising a siloxane matrix, the overcoat having a Martens hardness less than the Martens hardness of the basecoat.

Aspect 2 is the coated article of Aspect 1, wherein the organic polymer comprises at least one of polyphenylene sulfide (PPS), polyethersulfone (PES), polyether ether ketone (PEEK), polyphenylsulfone (PPSU), polyamide-imides (PAI), polyetherimides (PEI), polyimide (PI), and combinations thereof.

Aspect 3 is the coated article of either Aspect 1 or Aspect 2, wherein the reinforcing particles have an average particle size (D50) of 5 micrometers to 100 micrometers, as determined by scanning electron microscopy (SEM) analysis.

Aspect 4 is the coated article of any one of Aspects 1-3, wherein the reinforcing particles are present in an amount from 3 wt. % to 10 wt. %, based on a total weight of the basecoat.

Aspect 5 is the coated article of any one of Aspects 1-4, wherein the number of reinforcing particles present in the basecoat is at least 3 per 1 centimeter length of a transverse cross section of the basecoat.

Aspect 6 is the coated article of any one of Aspects 1-5, wherein the overcoat comprises a siloxane matrix with a Martens hardness of less than 0.2 GPa as determined by as determined by nano-indentation according to DIN ISO 14577 1-3.

Aspect 7 is the coated article of any one of Aspects 1-6, wherein the overcoat comprises a siloxane matrix formed from at least one siloxane.

Aspect 8 is the coated article of any one of Aspects 1-7, wherein the siloxane matrix is formed from at least one of: a hydrosilylation reaction between a siloxane and at least one of a hydride-substituted organosiloxane and a vinyl-substituted organosiloxane; a dehydrogenative coupling reaction between a hydride-substituted organosiloxane and a hydroxy-substituted organosiloxane; and a polycondensation reaction between two hydroxy-substituted organosiloxanes; an alkoxy-substituted organosiloxane and a hydroxy-substituted organosiloxane; or an acetoxy-substituted organosiloxane and a hydroxy-substituted organosiloxane.

Aspect 9 is the coated article of any one of Aspects 1-8, wherein the coating comprises less than 0.1 wt. % of a fluoropolymer, based on a total weight of the coating.

Aspect 10 is a coating system, comprising a basecoat composition, comprising at least one of: (i) at least one siloxane of formula (I)

RₓSi(OR′)₄₋ₓ (I)
wherein R is one or more moieties chosen independently from linear, branched, or cyclic alkyl and aryl; R′ is methyl, ethyl, propyl or alkyl; and x is 0, 1, 2, or 3; and (ii) an organic polymer having at least one of: a melt point of 200° C. or greater as determined by differential scanning calorimetry (DSC); a glass transition temperature of 90° C. or greater as determined by differential scanning calorimetry (DSC); and a heat deflection/distortion temperature of 100° C. or greater as determined by ASTM D648; and (iii) a silicone resin; and at least one type of reinforcing particles, having a Knoop hardness of 160 kg/m² as determined by ASTM C1326; and an average particle size (D50) of 5 microns to 100 microns, as determined by dynamic light scattering; and an overcoat composition, comprising at least one organosiloxane, and at least one catalyst.

Aspect 11 is the coating system of Aspect 10, wherein the organic polymer comprises at least one of polyphenylene sulfide (PPS), polyethersulfone (PES), polyether ether ketone (PEEK), polyphenylsulfone (PPSU), polyamide-imides (PAI), polyetherimides (PEI), polyimide (PI), and combinations thereof.

Aspect 12 is the coating system of Aspect 10 or Aspect 11, wherein the at least one type of reinforcing particles is present in an amount from 3 wt. % to 10 wt. %, based on a total weight of the basecoat composition.

Aspect 13 is the coating system of any one of Aspect 10-12, wherein the at least one type of reinforcing particles has a Knoop hardness of at least 160 kg/m² as determined by ASTM C1326.

Aspect 14 is the coating system of any one of Aspects 10-13, wherein the overcoat composition further comprises at least one of: an organosiloxane and at least one of a hydride-substituted organosiloxane, a vinyl-substituted organosiloxane, an acetoxy-substituted organosiloxane, a hydroxy-substituted organosiloxane, and an alkoxy-substituted organosiloxane, a hydride-substituted organosiloxane and a hydroxy-substituted organosiloxane, and at least one of a hydroxy-substituted organosiloxane, an acetoxy-substituted organosiloxane, and an alkoxy-substituted organosiloxane.

Aspect 15 is the coating system of any one of Aspects 10-14, wherein the catalyst comprises tin, titanium, platinum, palladium, ruthenium, gold, copper, zinc or zirconium.

Aspect 16 is the coating system of any one of Aspects 10-15, wherein the catalyst comprises an organoperoxide.

Aspect 17 is the coating system of any one of Aspects 10-16, wherein the catalyst comprises a protic acid, a Lewis acid, or a base.

Aspect 18 is the coating system of any one of Aspects 10-17, wherein the coating system comprises less than 0.1 wt. % of a fluoropolymer, based on a total weight of the basecoat composition and the overcoat composition.

Aspect 19 is the coated article of any one of Aspects 1-9, wherein the basecoat comprises a sol-gel matrix formed from at least one siloxane of formula (I)

RₓSi(OR′)₄₋ₓ (I)

wherein R is one or more moieties chosen independently from linear, branched, or cyclic alkyl and aryl; R′ is methyl, ethyl, propyl or alkyl; and x is 0, 1, 2, or 3.

Aspect 20 is the coated article of any one of Aspects 1-9, wherein the basecoat comprises an organic polymer having at least one of: a melt point of 200° C. or greater as determined by differential scanning calorimetry (DSC); a glass transition temperature of 90° C. or greater as determined by differential scanning calorimetry (DSC); and a heat deflection/distortion temperature of 100° C. or greater as determined by ASTM D648.

Aspect 21 is the coated article of any one of Aspects 1-9 or Aspect 20, wherein the basecoat comprises an organic polymer having a melt point of 200° C. or greater as determined by differential scanning calorimetry (DSC).

Aspect 22 is the coated article of any one of Aspects 1-9 or Aspect 20, wherein the basecoat comprises an organic polymer having a glass transition temperature of 90° C. or greater as determined by differential scanning calorimetry (DSC).

Aspect 23 is the coated article of any one of Aspects 1-9 or Aspect 20, wherein the basecoat comprises an organic polymer having a heat deflection/distortion temperature of 100° C. or greater as determined by ASTM D648.

Aspect 24 is the coated article of any one of Aspects 1-9 or Aspect 20, wherein the basecoat comprises an organic polymer having a melt point of 200° C. or greater as determined by differential scanning calorimetry (DSC) and a glass transition temperature of 90° C. or greater as determined by differential scanning calorimetry (DSC).

Aspect 25 is the coated article of any one of Aspects 1-9 or Aspect 20, wherein the basecoat comprises an organic polymer having a melt point of 200° C. or greater as determined by differential scanning calorimetry (DSC) and a heat deflection/distortion temperature of 100° C. or greater as determined by ASTM D648.

Aspect 26 is the coated article of any one of Aspects 1-9 or Aspect 20, wherein the basecoat comprises an organic polymer having a glass transition temperature of 90° C. or greater as determined by differential scanning calorimetry (DSC) and a heat deflection/distortion temperature of 100° C. or greater as determined by ASTM D648.

Aspect 27 is the coated article of any one of Aspects 1-9 or Aspect 20, wherein the basecoat comprises an organic polymer having a melt point of 200° C. or greater as determined by differential scanning calorimetry (DSC), a glass transition temperature of 90° C. or greater as determined by differential scanning calorimetry (DSC), and a heat deflection/distortion temperature of 100° C. or greater as determined by ASTM D648.

Aspect 28 is the coated article of any one of Aspects 1-9 or Aspects 20-27, wherein the organic polymer comprises at least one of polyphenylene sulfide (PPS), polyethersulfone (PES), polyether ether ketone (PEEK), polyphenylsulfone (PPSU), polyamide-imides (PAI), polyetherimides (PEI), polyimide (PI), and combinations thereof.

Aspect 29 is the coated article of any one of Aspects 1-9 or Aspects 20-28, wherein the organic polymer comprises polyphenlylene sulfide (PPS).

Aspect 30 is the coated article of any one of Aspects 1-9 or Aspects 20-28, wherein the organic polymer comprises polyethersulfone (PES).

Aspect 31 is the coated article of any one of Aspects 1-9 or Aspects 20-28, wherein the organic polymer comprises polyether ether ketone (PEEK).

Aspect 32 is the coated article of any one of Aspects 1-9 or Aspects 20-28, wherein the organic polymer comprises polyphenylsulfone (PPSU).

Aspect 33 is the coated article of any one of Aspects 1-9 or Aspects 20-28, wherein the organic polymer comprises polyamide-imide (PAI).

Aspect 34 is the coated article of any one of Aspects 1-9 or Aspects 20-28, wherein the organic polymer comprises polyetherimide (PEI).

Aspect 35 is the coated article of any one of Aspects 1-9 or Aspects 20-28, wherein the organic polymer comprises polyimide (PI).

Aspect 36 is the coated article of any one of Aspects 1-9 or Aspects 20-28, wherein the organic polymer comprises polyphenlylene sulfide (PPS) and polyethersulfone (PES).

Aspect 37 is the coated article of any one of Aspects 1-9 or Aspects 20-28, wherein the organic polymer comprises polyphenlylene sulfide (PPS) and polyether ether ketone (PEEK).

Aspect 38 is the coated article of any one of Aspects 1-9 or Aspects 20-28, wherein the organic polymer comprises polyphenlylene sulfide (PPS) and polyphenylsulfone (PPSU).

Aspect 39 is the coated article of any one of Aspects 1-9 or Aspects 20-28, wherein the organic polymer comprises polyphenlylene sulfide (PPS) and polyamide-imide (PAI).

Aspect 40 is the coated article of any one of Aspects 1-9 or Aspects 20-28, wherein the organic polymer comprises polyphenlylene sulfide (PPS) and polyetherimide (PEI).

Aspect 41 is the coated article of any one of Aspects 1-9 or Aspects 20-28, wherein the organic polymer comprises polyphenlylene sulfide (PPS) and polyimide (PI).

Aspect 42 is the coated article of any one of Aspects 1-9 or Aspects 20-28 wherein the organic polymer comprises polyethersulfone (PES) and polyether ether ketone (PEEK).

Aspect 43 is the coated article of any one of Aspects 1-9 or Aspects 20-28 wherein the organic polymer comprises polyethersulfone (PES) and polyphenylsulfone (PPSU).

Aspect 44 is the coated article of any one of Aspects 1-9 or Aspects 20-28 wherein the organic polymer comprises polyethersulfone (PES) and polyamide-imide (PAI).

Aspect 45 is the coated article of any one of Aspects 1-9 or Aspects 20-28 wherein the organic polymer comprises polyethersulfone (PES) and polyetherimide (PEI).

Aspect 46 is the coated article of any one of Aspects 1-9 or Aspects 20-28 wherein the organic polymer comprises polyethersulfone (PES) and polyimide (PI).

Aspect 47 is the coated article of any one of Aspects 1-9 or Aspects 20-27, wherein the organic polymer comprises polyether ether ketone (PEEK) and polyphenylsulfone (PPSU).

Aspect 48 is the coated article of any one of Aspects 1-9 or Aspects 20-27, wherein the organic polymer comprises polyether ether ketone (PEEK) and polyamide-imide (PAI).

Aspect 49 is the coated article of any one of Aspects 1-9 or Aspects 20-27, wherein the organic polymer comprises polyether ether ketone (PEEK) and polyetherimide (PEI).

Aspect 50 is the coated article of any one of Aspects 1-9 or Aspects 20-27, wherein the organic polymer comprises polyether ether ketone (PEEK) and polyimide (PI).

Aspect 51 is the coated article of any one of Aspects 1-9 or Aspects 20-27, wherein the organic polymer comprises polyphenylsulfone (PPSU) and polyamide-imides (PAI).

Aspect 52 is the coated article of any one of Aspects 1-9 or Aspects 20-27, wherein the organic polymer comprises polyphenylsulfone (PPSU) and polyetherimide (PEI).

Aspect 53 is the coated article of any one of Aspects 1-9 or Aspects 20-27, wherein the organic polymer comprises polyphenylsulfone (PPSU) and polyimide (PI).

Aspect 54 is the coated article of any one of Aspects 1-9 or Aspects 20-27, wherein the organic polymer comprises polyamide-imide (PAI) and polyetherimide (PEI).

Aspect 55 is the coated article of any one of Aspects 1-9 or Aspects 20-27, wherein the organic polymer comprises polyamide-imide (PAI) and polyimide (PI).

Aspect 56 is the coated article of any one of Aspects 1-9, wherein the basecoat comprises a silicone resin, the basecoat including at least one type of reinforcing particles having a Knoop hardness of at least 160 kg/m² as determined by ASTM C1326; and an overcoat disposed on the basecoat and comprising a siloxane matrix, the overcoat having a Martens hardness less than the Martens hardness of the basecoat.

Aspect 57 is the coated article of any one of Aspects 1-9 or Aspects 19-56, wherein the overcoat comprises a siloxane matrix formed from a hydrosilylation reaction between a siloxane and at least one of a hydride-substituted organosiloxane and a vinyl-substituted organosiloxane.

Aspect 58 is the coated article of any one of Aspects 1-9 or Aspects 19-56, wherein the overcoat comprises a siloxane matrix formed from a dehydrogenative coupling reaction between a hydride-substituted organosiloxane and a hydroxy-substituted organosiloxane.

Aspect 59 is the coated article of any one of Aspects 1-9 or Aspects 19-56, wherein the overcoat comprises a siloxane matrix formed from a polycondensation reaction between two hydroxy-substituted organosiloxanes.

Aspect 60 is the coated article of any one of Aspects 1-9 or Aspects 19-56, wherein the overcoat comprises a siloxane matrix formed from a polycondensation reaction between an alkoxy-substituted organosiloxane and a hydroxy-substituted organosiloxane.

Aspect 61 is the coated article of any one of Aspects 1-9 or Aspects 19-56, wherein the overcoat comprises a siloxane matrix formed from a polycondensation reaction between an acetoxy-substituted organosiloxane and a hydroxy-substituted organosiloxane.

Aspect 62 is the coated article of any one of Aspects 19-61, wherein the coating comprises less than 0.1 wt. % of a fluoropolymer, based on a total weight of the coating.

Aspect 63 is the coating system of any of Aspects 10-18, wherein the basecoat comprises a siloxane of formula (I)

RₓSi(OR′)₄₋ₓ (I)

wherein R is one or more moieties chosen independently from linear, branched, or cyclic alkyl and aryl; R′ is methyl, ethyl, propyl or alkyl; and x is 0, 1, 2, or 3.

Aspect 64 is the coating system of any one of Aspects 10-18, wherein the basecoat comprises an organic polymer having at least one of: a melt point of 200° C. or greater as determined by differential scanning calorimetry (DSC); a glass transition temperature of 90° C. or greater as determined by differential scanning calorimetry (DSC); and a heat deflection/distortion temperature of 100° C. or greater as determined by ASTM D648

Aspect 65 is the coating system of any one of Aspects 10-18 or Aspect 64 wherein the basecoat comprises an organic polymer having a melt point of 200° C. or greater as determined by differential scanning calorimetry (DSC).

Aspect 66 is the coating system of any one of Aspects 10-18 or Aspect 64, wherein the basecoat comprises an organic polymer having a glass transition temperature of 90° C. or greater as determined by differential scanning calorimetry (DSC).

Aspect 67 is the coating system of any one of Aspects 10-18 or Aspect 64, wherein the basecoat comprises an organic polymer having a heat deflection/distortion temperature of 100° C. or greater as determined by ASTM D648.

Aspect 68 is the coating system of any one of Aspects 10-18 or Aspect 64, wherein the basecoat comprises an organic polymer having a melt point of 200° C. or greater as determined by differential scanning calorimetry (DSC) and a glass transition temperature of 90° C. or greater as determined by differential scanning calorimetry (DSC).

Aspect 69 is the coating system of any one of Aspects 10-18 or Aspect 64, wherein the basecoat comprises an organic polymer having a melt point of 200° C. or greater as determined by differential scanning calorimetry (DSC) and a heat deflection/distortion temperature of 100° C. or greater as determined by ASTM D648.

Aspect 70 is the coating system of any one of Aspects 10-18 or Aspect 64, wherein the basecoat comprises an organic polymer having a glass transition temperature of 90° C. or greater as determined by differential scanning calorimetry (DSC) and a heat deflection/distortion temperature of 100° C. or greater as determined by ASTM D648.

Aspect 71 is the coating system of any one of Aspects 10-18 or Aspect 64, wherein the basecoat comprises an organic polymer having a melt point of 200° C. or greater as determined by differential scanning calorimetry (DSC), a glass transition temperature of 90° C. or greater as determined by differential scanning calorimetry (DSC), and a heat deflection/distortion temperature of 100° C. or greater as determined by ASTM D648.

Aspect 72 is the coating system of any one of Aspects 10-18 or Aspects 64-71, wherein the organic polymer comprises at least one of polyphenylene sulfide (PPS), polyethersulfone (PES), polyether ether ketone (PEEK), polyphenylsulfone (PPSU), polyamide-imides (PAI), polyetherimides (PEI), polyimide (PI), and combinations thereof.

Aspect 73 is the coating system of any one of Aspects 10-18 or Aspects 64-71, wherein the organic polymer comprises polyphenlylene sulfide (PPS).

Aspect 74 is the coating system of any one of Aspects 10-18 or Aspects 64-71, wherein the organic polymer comprises polyethersulfone (PES).

Aspect 75 is the coating system of any one of Aspects 10-18 or Aspects 64-71, wherein the organic polymer comprises polyether ether ketone (PEEK).

Aspect 76 is the coating system of any one of Aspects 10-18 or Aspects 64-71, wherein the organic polymer comprises polyphenylsulfone (PPSU).

Aspect 77 is the coating system of any one of Aspects 10-18 or Aspects 64-71, wherein the organic polymer comprises polyamide-imide (PAI).

Aspect 78 is the coating system of any one of Aspects 10-18 or Aspects 64-71, wherein the organic polymer comprises polyetherimide (PEI).

Aspect 79 is the coating system of any one of Aspects 10-18 or Aspects 64-71, wherein the organic polymer comprises polyimide (PI).

Aspect 80 is the coating system of any one of Aspects 10-18 or Aspects 64-71, wherein the organic polymer comprises polyphenlylene sulfide (PPS) and polyethersulfone (PES).

Aspect 81 is the coating system of any one of Aspects 10-18 or Aspects 64-71, wherein the organic polymer comprises polyphenlylene sulfide (PPS) and polyether ether ketone (PEEK).

Aspect 82 is the coating system of any one of Aspects 10-18 or Aspects 64-71, wherein the organic polymer comprises polyphenlylene sulfide (PPS) and polyphenylsulfone (PPSU).

Aspect 83 is the coating system of any one of Aspects 10-18 or Aspects 64-71, wherein the organic polymer comprises polyphenlylene sulfide (PPS) and polyamide-imide (PAI).

Aspect 84 is the coating system of any one of Aspects 10-18 or Aspects 64-71, wherein the organic polymer comprises polyphenlylene sulfide (PPS) and polyetherimide (PEI).

Aspect 85 is the coating system of any one of Aspects 10-18 or Aspects 64-71, wherein the organic polymer comprises polyphenlylene sulfide (PPS) and polyimide (PI).

Aspect 86 is the coating system of any one of Aspects 10-18 or Aspects 64-71, wherein the organic polymer comprises polyethersulfone (PES) and polyether ether ketone (PEEK).

Aspect 87 is the coating system of any one of Aspects 10-18 or Aspects 64-71, wherein the organic polymer comprises polyethersulfone (PES) and polyphenylsulfone (PPSU).

Aspect 88 is the coating system of any one of Aspects 10-18 or Aspects 64-71, wherein the organic polymer comprises polyethersulfone (PES) and polyamide-imide (PAI).

Aspect 89 is the coating system of any one of Aspects 10-18 or Aspects 64-71, wherein the organic polymer comprises polyethersulfone (PES) and polyetherimide (PEI).

Aspect 90 is the coating system of any one of Aspects 10-18 or Aspects 64-71, wherein the organic polymer comprises polyethersulfone (PES) and polyimide (PI).

Aspect 91 is the coating system of any one of Aspects 10-18 or Aspects 64-71, wherein the organic polymer comprises polyether ether ketone (PEEK) and polyphenylsulfone (PPSU).

Aspect 92 is the coating system of any one of Aspects 10-18 or Aspects 64-71, wherein the organic polymer comprises polyether ether ketone (PEEK) and polyamide-imide (PAI).

Aspect 93 is the coating system of any one of Aspects 10-18 or Aspects 64-71, wherein the organic polymer comprises polyether ether ketone (PEEK) and polyetherimide (PEI).

Aspect 94 is the coating system of any one of Aspects 10-18 or Aspects 64-71, wherein the organic polymer comprises polyether ether ketone (PEEK) and polyimide (PI).

Aspect 95 is the coating system of any one of Aspects 10-18 or Aspects 64-71, wherein the organic polymer comprises polyphenylsulfone (PPSU) and polyamide-imides (PAI).

Aspect 96 is the coating system of any one of Aspects 10-18 or Aspects 64-71, wherein the organic polymer comprises polyphenylsulfone (PPSU) and polyetherimide (PEI).

Aspect 97 is the coating system of any one of Aspects 10-18 or Aspects 64-71, wherein the organic polymer comprises polyphenylsulfone (PPSU) and polyimide (PI).

Aspect 98 is the coating system of any one of Aspects 10-18 or Aspects 64-71, wherein the organic polymer comprises polyamide-imide (PAI) and polyetherimide (PEI).

Aspect 99 is the coating system of any one of Aspects 10-18 or Aspects 64-71, wherein the organic polymer comprises polyamide-imide (PAI) and polyimide (PI).

Aspect 100 is the coating system of any one of Aspects 10-18, wherein the basecoat comprises a silicone resin, the basecoat including reinforcing particles having a Knoop hardness of at least 160 kg/m² as determined by ASTM C1326; and an overcoat disposed on the basecoat and comprising an organosiloxane.

Aspect 101 is the coating system of any one of Aspects 10-18 or Aspects 63-100, wherein the overcoat is formed from a hydrosilylation reaction between a siloxane and at least one of a hydride-substituted organosiloxane and a vinyl-substituted organosiloxane.

Aspect 102 is the coating system of any one of Aspects 10-18 or Aspects 63-100, wherein the overcoat is formed from a dehydrogenative coupling reaction between a hydride-substituted organosiloxane and a hydroxy-substituted organosiloxane.

Aspect 103 is the coating system of any one of Aspects 10-18 or Aspects 63-100, wherein the overcoat is formed from a polycondensation reaction between two hydroxy-substituted organosiloxanes.

Aspect 104 is the coating system of any one of Aspects 10-18 or Aspects 63-100, wherein the overcoat is formed from a polycondensation reaction between an alkoxy-substituted organosiloxane and a hydroxy-substituted organosiloxane.

Aspect 105 is the coating system of any one of Aspects 10-18 or Aspects 63-100, wherein the overcoat is formed from a polycondensation reaction between an acetoxy-substituted organosiloxane and a hydroxy-substituted organosiloxane.

Aspect 106 is the coating system of any one of Aspects 63-105, wherein the coating system comprises less than 0.1 wt. % of a fluoropolymer, based on a total weight of the basecoat composition and the overcoat composition.

Aspect 107 is the coated article of any one of Aspects 1-9 wherein the basecoat comprises a sol-gel matrix and an organic polymer of any one of Aspects 20-55.

Aspect 108 is the coated article of any one of Aspects 1-9, wherein the basecoat comprises a sol-gel matrix and a silicon resin.

Aspect 109 is the coated article of any one of Aspects 1-9, wherein the basecoat comprises a silicon resin and an organic polymer of any one of Aspects 20-55.

Aspect 110 is the coating system of any one of Aspects 10-18, wherein the basecoat comprises a sol-gel matrix and an organic polymer of any one of Aspects 64-99.

Aspect 111 is the coating system of any one of Aspects 10-18, wherein the basecoat comprises a sol-gel matrix and a silicon resin.

Aspect 112 is the coating system of any one of Aspects 10-18, wherein the basecoat comprises a silicon resin an organic polymer of any one of Aspects 64-99.

Aspect 113 is the coated article of any of Aspects 1-63 or the coating system of any of Aspects 64-112, wherein the overcoat composition comprises a vinyl-terminated polydimethylsiloxane, a polydimethylsiloxane including hydride groups, a co-binder comprising a vinyl Q resin; and filler particles having an aspect ratio of length to width of at least 3:1.

Aspect 114 is a coating composition, comprising a vinyl-terminated polydimethylsiloxane, a polydimethylsiloxane including hydride groups, a co-binder comprising a vinyl Q resin; and filler particles having an aspect ratio of length to width of at least 3:1.

Aspect 115 is the coating system of Aspect 114, wherein the vinyl-terminated polydimethylsiloxane has a viscosity from 1,000 and 50,000 cSt, as determined by as determined by determined by ASTM D445-21e1.

Aspect 116 is the coating system of Aspect 114 or Aspect 115, wherein the polydimethylsiloxane including hydride groups has from 30 mol % to 50 mol % hydride groups.

Aspect 117 is a coated article, comprising a substrate having a surface and a coating disposed on the surface, comprising a basecoat having at least one of: a Martens hardness of 0.2 GPa or higher, as determined by nano-indentation according to DIN ISO 14577 1-3; and an elastic modulus of 5 GPa or higher, as determined by DIN ISO 14577 1-3; and the basecoat comprising at least one of a sol-gel matrix, an organic polymer, and a silicone resin, the basecoat including reinforcing particles having a Knoop hardness of at least 160 kg/m² as determined by ASTM C1326; and an overcoat disposed on the basecoat and comprising a siloxane matrix, the overcoat having a Martens hardness less than the Martens hardness of the basecoat, and further comprising: a vinyl-terminated polydimethylsiloxane; a polydimethylsiloxane including hydride groups; a co-binder comprising a vinyl Q resin; and filler particles having an aspect ratio of length to width of at least 3:1.

Aspect 118 is the coating system of Aspect 117, wherein the vinyl-terminated polydimethylsiloxane has a viscosity from 1,000 and 50,000 cSt, as determined by determined by ASTM D445-21e1.

Aspect 119 is the coating system of Aspect 117 or Aspect 118, wherein the polydimethylsiloxane including hydride groups has from 30 mol % to 50 mol % hydride groups.

Aspect 120 is the coated article of any one of Aspects 117-119, wherein the overcoat further comprises at least one of the following: the vinyl-terminated polydimethylsiloxane is present in an amount from 40 wt. % to 60 wt. %, based on a total solids weight of the coating; the polydimethylsiloxane including hydride groups is present in an amount from 25 wt. % to 40 wt. %, based on a total solids weight of the coating; the co-binder is present in an amount from 15 wt. % to 25 wt. %, based on a total solids weight of the coating; and the filler is present in an amount from 2 wt. % to 7.5 wt. %, based on a total solids weight of the coating.

1. A coated article, comprising:
a substrate having a surface; and
a coating disposed on the surface, comprising:
a basecoat having at least one of:
a Martens hardness of 0.2 GPa or higher, as determined by nano-indentation according to DIN ISO 14577 1-3; and
an elastic modulus of 5 GPa or higher, as determined by DIN ISO 14577 1-3, the basecoat comprising at least one of:
(i) a sol-gel matrix formed from at least one siloxane of formula (I)
RₓSi(OR′)₄₋ₓ (I)
wherein:
R is one or more moieties chosen independently from linear, branched, or cyclic alkyl and aryl;
R′ is methyl, ethyl, propyl or alkyl; and
x is 0, 1, 2, or 3;
(ii) an organic polymer having at least one of:
a melt point of 200° C. or greater as determined by differential scanning calorimetry (DSC);
a glass transition temperature of 90° C. or greater as determined by differential scanning calorimetry (DSC); and
a heat deflection/distortion temperature of 100° C. or greater as determined by ASTM D648; and
(iii) a silicone resin, the basecoat including reinforcing particles having a Knoop hardness of at least 160 kg/m² as determined by ASTM C1326; and
an overcoat disposed on the basecoat and comprising a siloxane matrix, the overcoat having a Martens hardness less than the Martens hardness of the basecoat.

2. The coated article of claim 1, wherein the organic polymer comprises at least one of polyphenylene sulfide (PPS), polyethersulfone (PES), polyether ether ketone (PEEK), polyphenylsulfone (PPSU), polyamide-imides (PAI), polyetherimides (PEI), polyimide (PI), and combinations thereof.

3. The coated article of claim 1, wherein the reinforcing particles have an average particle size (D50) of 5 micrometers to 100 micrometers, as determined by scanning electron microscopy (SEM) analysis.

4. The coated article of claim 1, wherein the reinforcing particles are present in an amount from 3 wt. % to 10 wt. %, based on a total weight of the basecoat.

5. The coated article of claim 1, wherein a number of reinforcing particles present in the basecoat is at least 3 per 1 centimeter length of a transverse cross section of the basecoat.

6. The coated article of claim 1, wherein the overcoat comprises a siloxane matrix with a Martens hardness of less than 0.2 GPa as determined by as determined by nano-indentation according to DIN ISO 14577 1-3.

7. (canceled)

8. (canceled)

9. The coated article of claim 1, wherein the siloxane matrix of the overcoat is formed from a hydrosilylation reaction between a vinyl-terminated polydimethylsiloxane and a polydimethylsiloxane including hydride groups, together with a co-binder comprising a vinyl Q resin, and further comprises filler particles having an aspect ratio of length to width of at least 3:1.

10. The coated article of claim 1, wherein the coating comprises less than 0.1 wt. % of a fluoropolymer, based on a total weight of the coating.

11. (canceled)

12. A coating system, comprising:
a basecoat composition, comprising at least one of:
(i) at least one siloxane of formula (I)
RₓSi(OR′)₄₋ₓ (I)
wherein:
R is one or more moieties chosen independently from linear, branched, or cyclic alkyl and aryl;
R′ is methyl, ethyl, propyl or alkyl; and
x is 0, 1, 2, or 3; and
(ii) an organic polymer having at least one of
a melt point of 200° C. or greater as determined by differential scanning calorimetry (DSC);
a glass transition temperature of 90° C. or greater as determined by differential scanning calorimetry (DSC); and
a heat deflection/distortion temperature of 100° C. or greater as determined by ASTM D648; and
(iii) a silicone resin; and
reinforcing particles having a Knoop hardness of 160 kg/m² as determined by ASTM C1326; and an average particle size (D50) of 5 microns to 100 microns, as determined by dynamic light scattering; and
an overcoat composition, comprising at least one organosiloxane, and
at least one catalyst.

13. The coating system of claim 12, wherein the organic polymer comprises at least one of polyphenylene sulfide (PPS), polyethersulfone (PES), polyether ether ketone (PEEK), polyphenylsulfone (PPSU), polyamide-imides (PAI), polyetherimides (PEI), polyimide (PT), and combinations thereof.

14. The coating system of claim 13, wherein the reinforcing particles are present in an amount from 3 wt. % to 10 wt. %, based on a total weight of the basecoat composition.

15. The coating system of claim 12, wherein the reinforcing particles have a Knoop hardness of at least 160 kg/m² as determined by ASTM C1326.

16. (canceled)

17. The coating system of claim 12, wherein the overcoat
composition comprises a vinyl-terminated polydimethylsiloxane;
a polydimethylsiloxane including hydride groups;
a co-binder comprising a vinyl Q resin; and
filler particles having an aspect ratio of length to width of at least 3:1.

18. The coating system of claim 12, wherein the catalyst comprises tin, titanium, platinum, palladium, ruthenium, gold, copper, zinc or zirconium.

19. The coating system of claim 12, wherein the catalyst comprises an organoperoxide.

20. The coating system of claim 12, wherein the catalyst comprises a protic acid, a Lewis acid, or a base.

21. The coating system of claim 12, wherein the coating system comprises less than 0.1 wt. % of a fluoropolymer, based on a total weight of the basecoat composition and the overcoat composition.

22. (canceled)

23. (canceled)

24. (canceled)

25. A coated article, comprising:
a substrate having a surface; and
a coating disposed on the surface, comprising:
a basecoat having at least one of:
a Martens hardness of 0.2 GPa or higher, as determined by nano-indentation according to DIN ISO 14577 1-3; and
an elastic modulus of 5 GPa or higher, as determined by DIN ISO 14577 1-3; and
the basecoat comprising at least one of a sol-gel matrix, an organic polymer, and a silicone resin, the basecoat including reinforcing particles having a Knoop hardness of at least 160 kg/m² as determined by ASTM C1326; and
an overcoat disposed on the basecoat and comprising a siloxane matrix, the overcoat having a Martens hardness less than the Martens hardness of the basecoat, and further comprising:
a vinyl-terminated polydimethylsiloxane;
a polydimethylsiloxane including hydride groups;
a co-binder comprising a vinyl Q resin; and
filler particles having an aspect ratio of length to width of at least 3:1.

26. The coating system of claim 25, wherein the vinyl-terminated polydimethylsiloxane has a viscosity from 1,000 and 50,000 cSt, as determined by determined by ASTM D445-21e1.

27. The coating system of claim 25, wherein the polydimethylsiloxane including hydride groups has from 30 mol % to 50 mol % hydride groups.

28. (canceled)
